(19) United States
(12) Patent Application Publication
(10) Pub. No.: US 2026/0067919 A1
(43) Pub. Date: Mar. 5, 2026

(54) INFORMATION PROCESSING METHOD, INFORMATION PROCESSING APPARATUS, COMMUNICATION DEVICE, AND READABLE STORAGE MEDIUM

(71) Applicant: VIVO MOBILE COMMUNICATION CO., LTD., Dongguan (CN)

(72) Inventor: Xiaowan KE, Dongguan (CN)

(73) Assignee: VIVO MOBILE COMMUNICATION CO., LTD., Dongguan (CN)

(21) Appl. No.: 19/385,183

(22) Filed: Nov. 11, 2025

Related U.S. Application Data
(63) Continuation of application No. PCT/CN2024/091299, filed on May 7, 2024.

(30) Foreign Application Priority Data
May 11, 2023 (CN) 202310535424.7

(51) Int. Cl. H04W 72/543

(52) U.S. Cl. CPC H04W 72/543

(57) ABSTRACT

An information processing method, an information processing apparatus, a communication device, and a readable storage medium, are provided. The method includes: when a tenth condition is met, performing a third operation. The third operation includes: determining to apply Protocol Data Unit (PDU) Set based handling. The applying PDU Set based handling includes: applying PDU Set Quality of Service (QoS). The tenth condition includes: a second communication device supports PDU Set based handling, or supports PDU Set based handling in uplink. The second communication device includes a Radio Access Network (RAN) node.

### CROSS-REFERENCE TO RELATED APPLICATIONS

This application is a continuation of International Application No. PCT/CN2024/091299, filed May 7, 2024, which claims priority to Chinese Patent No. 202310535424.7, filed May 11, 2023. The entire contents of each of the above-referenced applications are expressly incorporated herein by reference.

### TECHNICAL FIELD

This application pertains to the field of wireless communications technologies, and specifically relates to an information processing method, an information processing apparatus, a communication device, and a readable storage medium.

### BACKGROUND

Protocol Data Unit Set (PDU Set) (also referred to data packet set) handling, includes at least one of PDU Set Quality of Service (PDU Set QoS)-based handling and PDU Set Importance-based handling. However, how a terminal, a Radio Access Network (RAN), and a core network cooperate to determine whether PDU Set based handling can be performed in uplink and how to perform PDU Set integrated handling have not been discussed.

### SUMMARY

Embodiments of this application provide an information processing method, an information processing apparatus, a communication device, and a readable storage medium.

According to a first aspect, an information processing method is provided, where the method is executed by a first communication device, and the method includes:
performing, by a first communication device, a first operation, where the first operation includes at least one of the following:
sending at least one of the following to a second communication device: a second request and first capability information; and
sending at least one of the following to a core network element: a first request, the first capability information, and requested PDU Set QoS; where
the first request or the second request is used to request PDU Set based handling; and
the first capability information is used for indicating one of the following: PDU Set based handling is supported for a terminal, PDU Set based handling is supported for the terminal, uplink PDU Set based handling is supported for the terminal, or uplink PDU Set based handling is not supported for the terminal.

According to a second aspect, an information processing method is provided, where the method is executed by a second communication device, and the method includes:
performing, by a second communication device, a second operation, where the second operation includes at least one of the following:
determining to apply or not to apply PDU Set based handling, or determining to apply or not to apply PDU Set based handling to uplink;
determining that PDU Set based handling is supported or not supported, or determining that PDU Set based handling is supported or not supported in uplink;
receiving at least one of the following sent by a first communication device: a second request and first capability information;
sending at least one of the following to a core network element based on at least one of the second request and the first capability information: a first request, the first capability information, and fifth information, where the fifth information is used for indicating one of the following: PDU Set based handling is supported in uplink or PDU Set based handling is not supported in uplink;
receiving first information sent by the core network element; and
performing a first sub-operation of the second operation based on at least one of the first information, the first capability information, and the second request.

The first sub-operation of the second operation includes at least one of the following:
accepting the second request or rejecting the second request;
determining to apply or not to apply PDU Set based handling, or determining to apply or not to apply PDU Set based handling to uplink;
sending at least one of the following to the first communication device: third information, fourth information, and a second response; and
sending fifth information to a third communication device.

The first request or the second request is used to request PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the first information includes at least one of the following: PDU Set QoS, second information, the third information, the fourth information, and a first response;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, or supporting or not supporting PDU Set based handling in downlink;
the first response includes information for accepting or rejecting a first request; and
the second response includes information for accepting or rejecting a second request.

According to a third aspect, an information processing method is provided, where the method is executed by a third communication device, and the method includes:
performing, by a third communication device, a third operation, where the third operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
based on at least one of the requested PDU Set QoS, the first request, the fifth information, and the first capability information, performing a first sub-operation of the third operation, or performing a second sub-operation of the third operation.

The first sub-operation of the third operation includes at least one of the following:
accepting the first request or rejecting the first request;
determining at least one of the PDU Set QoS, the second information, the third information, the fourth information, and a first response; and
sending at least one of the following to at least one of a first communication device and a second communication device: the PDU Set QoS, the second information, the third information, the fourth information, and the first response.

The second sub-operation of the third operation includes at least one of the following:
determining, based on a first request of a first QoS flow, a first request corresponding to a first policy; and
sending at least one of the requested PDU Set QoS, a first request, fifth information, and first capability information to a fourth communication device.

The first request is used to request at least one of the following: PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

According to a fourth aspect, an information processing method is provided, where the method is executed by a fourth communication device, and the method includes:
performing, by a fourth communication device, a fourth operation, where the fourth operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
performing a first sub-operation of the fourth operation based on at least one of the requested PDU Set QoS, the first request, the fifth information, and the first capability information.

The first sub-operation of the fourth operation includes at least one of the following:
accepting the first request or rejecting the first request; and
sending at least one of the following to a third communication device: the PDU Set QoS, the second information, the third information, the fourth information, and a first response.

The first request is used to request at least one of the following: PDU Set based handling, and a PDU Set parameter;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

According to a fifth aspect, an information processing apparatus is provided, including:
a first operation module, configured to perform a first operation, where the first operation includes at least one of the following:
sending at least one of the following to a second communication device: a second request and first capability information; and
sending at least one of the following to a core network element: a first request, the first capability information, and requested PDU Set QoS.

The first request or the second request is used to request PDU Set based handling; and
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal.

According to a sixth aspect, an information processing apparatus is provided, including:
a second operation module, configured to perform a second operation, where the second operation includes at least one of the following:
determining to apply or not to apply PDU Set based handling, or determining to apply or not to apply PDU Set based handling to uplink;
determining that PDU Set based handling is supported or not supported, or determining that PDU Set based handling is supported or not supported in uplink;
receiving at least one of the following sent by a first communication device: a second request and first capability information;
sending at least one of the following to a core network element based on at least one of the second request and the first capability information: a first request, the first capability information, and fifth information, where the fifth information is used for indicating one of the following: information that PDU Set based handling is supported in uplink and information that PDU Set based handling is not supported in uplink;
receiving first information sent by the core network element; and
performing a first sub-operation of the second operation based on at least one of the first information, the first capability information, and the second request.

The first sub-operation of the second operation includes at least one of the following:
accepting the second request or rejecting the second request;
determining to apply or not to apply PDU Set based handling, or determining to apply or not to apply PDU Set based handling to uplink;
sending at least one of the following to the first communication device: third information, fourth information, and a second response; and
sending fifth information to a third communication device.

The first request or the second request is used to request PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the first information includes at least one of the following: PDU Set QoS, second information, the third information, the fourth information, and a first response;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the first response includes information for accepting or rejecting a first request; and
the second response includes information for accepting or rejecting a second request.

According to a seventh aspect, an information processing apparatus is provided, including:
a third operation module, configured to perform a third operation, where the third operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
based on at least one of the requested PDU Set QoS, the first request, the fifth information, and the first capability information, performing a first sub-operation of the third operation, or performing a second sub-operation of the third operation.

The first sub-operation of the third operation includes at least one of the following:
accepting the first request or rejecting the first request;
determining at least one of the PDU Set QoS, the second information, the third information, the fourth information, and a first response; and
sending at least one of the following to at least one of a first communication device and a second communication device: the PDU Set QoS, the second information, the third information, the fourth information, and the first response.

The second sub-operation of the third operation includes at least one of the following:
determining, based on a first request of a first QoS flow, a first request corresponding to a first policy; and
sending at least one of the requested PDU Set QoS, a first request, fifth information, and first capability information to a fourth communication device.

The first request is used to request at least one of the following: PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

According to an eighth aspect, an information processing apparatus is provided, including:
a fourth operation module, configured to perform a fourth operation, where the fourth operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
performing a first sub-operation of the fourth operation based on at least one of the requested PDU Set QoS, the first request, the fifth information, and the first capability information.

The first sub-operation of the fourth operation includes at least one of the following:
accepting the first request or rejecting the first request; and
sending at least one of the following to a third communication device: the PDU Set QoS, the second information, the third information, the fourth information, and a first response.

The first request is used to request at least one of the following: PDU Set based handling, and a PDU Set parameter;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

According to a ninth aspect, a communication device is provided, including a processor and a memory, where a program or instructions capable of running on the processor are stored in the memory, and when the program or instructions are executed by the processor, the steps of the method according to the first aspect, the second aspect, the third aspect, or the fourth aspect are implemented.

According to a tenth aspect, a communication device is provided, including a processor and a communication interface, where the processor is configured to perform a first operation, and the first operation includes at least one of the following:
sending at least one of the following to a second communication device: a second request and first capability information; and
sending at least one of the following to a core network element: a first request, the first capability information, and requested PDU Set QoS.

The first request or the second request is used to request PDU Set based handling; and
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal.

According to an eleventh aspect, a communication device is provided, including a processor and a communication interface, where the processor is configured to perform a second operation, and the second operation includes at least one of the following:
determining to apply or not to apply PDU Set based handling, or determining to apply or not to apply PDU Set based handling to uplink;
determining that PDU Set based handling is supported or not supported, or determining that PDU Set based handling is supported or not supported in uplink;
receiving at least one of the following sent by a first communication device: a second request and first capability information;
sending at least one of the following to a core network element based on at least one of the second request and the first capability information: a first request, the first capability information, and fifth information, where the fifth information is used for indicating one of the following: information that PDU Set based handling is supported in uplink and information that PDU Set based handling is not supported in uplink;
receiving first information sent by the core network element; and
performing a first sub-operation of the second operation based on at least one of the first information, the first capability information, and the second request.

The first sub-operation of the second operation includes at least one of the following:
accepting the second request or rejecting the second request;
determining to apply or not to apply PDU Set based handling, or determining to apply or not to apply PDU Set based handling to uplink;
sending at least one of the following to the first communication device: third information, fourth information, and a second response; and
sending fifth information to a third communication device.

The first request or the second request is used to request PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the first information includes at least one of the following: PDU Set QoS, second information, the third information, the fourth information, and a first response;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the first response includes information for accepting or rejecting a first request; and
the second response includes information for accepting or rejecting a second request.

According to a twelfth aspect, a communication device is provided, including a processor and a communication interface, where the processor is configured to perform a third operation, and the third operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
based on at least one of the requested PDU Set QoS, the first request, the fifth information, and the first capability information, performing a first sub-operation of the third operation, or performing a second sub-operation of the third operation.

The first sub-operation of the third operation includes at least one of the following:
accepting the first request or rejecting the first request;
determining at least one of the PDU Set QoS, the second information, the third information, the fourth information, and a first response; and
sending at least one of the following to at least one of a first communication device and a second communication device: the PDU Set QoS, the second information, the third information, the fourth information, and the first response;
where
the second sub-operation of the third operation includes at least one of the following:
determining, based on a first request of a first QoS flow, a first request corresponding to a first policy; and
sending at least one of the requested PDU Set QoS, a first request, fifth information, and first capability information to a fourth communication device.

The first request is used to request at least one of the following: PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

According to a thirteenth aspect, a communication device is provided, including a processor and a communication interface, where the processor is configured to perform a fourth operation, and the fourth operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
performing a first sub-operation of the fourth operation based on at least one of the requested PDU Set QoS, the first request, the fifth information, and the first capability information.

The first sub-operation of the fourth operation includes at least one of the following:
accepting the first request or rejecting the first request; and
sending at least one of the following to a third communication device: the PDU Set QoS, the second information, the third information, the fourth information, and a first response.

The first request is used to request at least one of the following: PDU Set based handling, and a PDU Set parameter;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

According to a fourteenth aspect, a readable storage medium is provided, where a program or instructions are stored in the readable storage medium. When the program or the instructions are executed by a processor, the steps of the method according to the first aspect, the second aspect, the third aspect, or the fourth aspect are implemented.

According to a fifteenth aspect, a wireless communication system is provided, including a first communication device, a second communication device, and a third communication device, where the first communication device can be configured to execute the steps of the method according to the first aspect, the second communication device can be configured to execute the steps of the method according to the second aspect, and the third communication device can be configured to execute the steps of the method according to the third aspect.

According to a sixteenth aspect, a wireless communication system is provided, including a first communication device, a second communication device, a third communication device, and a fourth communication device, where the first communication device can be configured to execute the steps of the method according to the first aspect, the second communication device can be configured to execute the steps of the method according to the second aspect, the third communication device can be configured to execute the steps of the method according to the third aspect, and the fourth communication device can be configured to execute the steps of the method according to the fourth aspect.

According to a seventeenth aspect, a chip is provided, where the chip includes a processor and a communication interface, the communication interface is coupled to the processor, and the processor is configured to run a program or instructions to implement the method according to the first aspect, the second aspect, the third aspect, or the fourth aspect.

According to an eighteenth aspect, a computer program/program product is provided, where the computer program/program product is stored in a storage medium, and the program/program product is executed by at least one processor to implement the steps of the method according to the first aspect, the second aspect, the third aspect, or the fourth aspect.

### BRIEF DESCRIPTION OF DRAWINGS

FIG. 1 is a block diagram of a wireless communications system to which embodiments of this application may be applied;

FIG. 2 is a first schematic flowchart of an information processing method according to an embodiment of this application;

FIG. 3 is a second schematic flowchart of an information processing method according to an embodiment of this application;

FIG. 4 is a third schematic flowchart of an information processing method according to an embodiment of this application;

FIG. 5 is a fourth schematic flowchart of an information processing method according to an embodiment of this application;

FIG. 6 is a schematic flowchart of an information processing method according to embodiment 1 of this application;

FIG. 7 is a schematic flowchart of an information processing method according to embodiment 2 of this application;

FIG. 8 is a schematic flowchart of an information processing method according to embodiment 3 of this application;

FIG. 9 is a schematic flowchart of an information processing method according to embodiment 4 of this application;

FIG. 10 is a schematic flowchart of an information processing method according to embodiment 5 of this application;

FIG. 11 is a first block diagram of an information processing apparatus according to an embodiment of this application;

FIG. 12 is a second block diagram of an information processing apparatus according to an embodiment of this application;

FIG. 13 is a third block diagram of an information processing apparatus according to an embodiment of this application;

FIG. 14 is a fourth block diagram of an information processing apparatus according to an embodiment of this application;

FIG. 15 is a first block diagram of a communication device according to an embodiment of this application;

FIG. 16 is a block diagram of a terminal according to an embodiment of this application;

FIG. 17 is a first block diagram of a network-side device according to an embodiment of this application; and

FIG. 18 is a second block diagram of a network-side device according to an embodiment of this application.

### DETAILED DESCRIPTION

The following describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first,” “second,” and the like in this application are used to distinguish between similar objects instead of describing a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, the “or” in this application means at least one of the associated objects. For example, “A or B” covers three schemes, namely, scheme 1: including A not B; scheme 2: including B not A; and scheme 3: including both A and B. The character “/” generally indicates an “or” relationship between associated objects.

The term “indication” in this application may be either a direct indication (or an explicit indication) or an indirect indication (or an implicit indication). The direct indication may be understood as: a sender explicitly notifies, in a sent indication, a receiver of content such as specific information, an operation that needs to be performed, or a request result; and the indirect indication may be understood as: the receiver determines corresponding information or performs determining according to the indication sent by the sender, and determines, according to a determining result, an operation that needs to be performed or a request result.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), or Single-carrier Frequency-Division Multiple Access (SC-FDMA), or other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other systems than an NR system, for example, the 6^{th} Generation (6G) communication system.

To resolve the problems of whether PDU Set based handling can be applied to uplink and how to apply, the following problems need to be resolved.

Problem 1: In a case that a first QoS flow has a corresponding PDU Set parameter, PDU Set QoS handling may not be required for uplink. For example, PDU Set QoS is not supported for a terminal, or an application of the terminal does not require PDU Set QoS handling. In a case that PDU Set based handling is not required, uplink PDU Error Rate (PER) cannot be replaced by PDU Set Error Rate (PSER), and uplink PDU Delay Budget (PDB) cannot be replaced by PDU Set Delay Budget (PSDB).

Solution 1: A Core Network (CN) needs to determine, based on a request of User Equipment (UE, also referred to as terminal) or UE capability, whether to apply PDU Set based handling to uplink. For example, in a case that PDU Set based handling is not supported for the UE or the UE does not request PDU Set based handling, the CN indicates a Radio Access Network (RAN) not to apply PDU Set based handling to uplink.

Solution 2: The CN needs to determine, based on a request sent by the RAN, whether to apply PDU Set based handling to uplink. The RAN may initiate a request (for example, a first request) to the CN based on the request (for example, a second request) of the UE. The RAN determines, according to an indication of the CN, whether to perform PDU Set based handling in uplink.

Solution 3: The CN sends PDU Set parameters (including PDU Set QoS and PDU Set importance) to the RAN. The RAN determines, based on the capability or request of the UE, whether to apply PDU Set based handling to uplink.

Question 1.1: The CN may not have a PDU Set QoS parameter corresponding to the first QoS flow. That is, the request of the UE or the RAN may be rejected. To further improve efficiency, the UE or the RAN may send the foregoing request based on a PDU Set based handling support status.

For example, in manner 1, the CN sends, to the RAN, information that the first QoS flow supports PDU Set based handling. The UE sends, to the RAN, a second request for requesting PDU Set based handling corresponding to the first QoS flow or a first radio bearer. The RAN sends a first request for requesting PDU Set based handling to the CN based on the PDU Set based handling supported information sent by the CN.

For example, in manner 2, the CN sends the first QoS flow to the UE to support PDU Set based handling. The UE sends a first request for requesting PDU Set based handling to the CN based on the PDU Set based handling supported information sent by the CN.

For example, in manner 3, the RAN sends, to the UE, information that the first QoS flow supports PDU Set based handling. The UE sends a second request for requesting PDU Set based handling to the RAN based on the PDU Set based handling supported information sent by the RAN.

Problem 2: When the UE requests to perform PDU Set based handling on the first QoS flow or the first radio bearer, the first QoS flow may have no corresponding PDU Set parameter (including at least one of the following: PDU Set QoS, second information, and PDU Set importance). In this case, how to trigger the CN to configure the PDU Set parameter for the RAN needs to be resolved. For example, for one service, PDU Set based handling is required only for uplink and PDU Set based handling is not required for downlink. Before the UE requests or the RAN requests, the CN does not need to send a corresponding PDU Set parameter to the RAN.

Solution 1: The CN sends the PDU Set parameter according to the request of the UE.

Solution 2: The CN sends the PDU Set parameter according to the request of the RAN. The request of the RAN may be based on the request of the UE.

Problem 3: Packet discarding based on PDU Set importance is a method for PDU Set based handling, but does not belong to PDU Set QoS. At present, the control plane still lacks an indication to inform the RAN whether packet discarding handling needs to be performed based on PDU Set importance.

Solution: The Control Plane (CP) informs the RAN to perform handling based on PDU Set importance, for example, to perform packet discarding based on PDU Set importance in a case of congestion.

Note: Scenarios where the UE requests PDU Set based handling for downlink or an AF requests PDU Set based handling for uplink are not excluded. The CN may trigger bidirectional PDU Set QoS handling based on a unidirectional status.

| | | | | |
|---|---|---|---|---|
| Scenario | PDU Set QoS is | The CN | The RAN | The RAN guarantees |
| 1 | present when a | determines PDU | receives | PDU Set QoS at least |
| | QoS flow is | Set QoS handling | PDU Set | for downlink. |
| | established. | (for example, | QoS from | Whether PDU Set QoS |
| | | based on a PDU | the SMF. | is guaranteed for uplink |
| | | Set QoS request | | depends on a request of |
| | | from the AF or a | | the UE, depending on |
| | | local policy of a | | interaction between the |
| | | PCF or an SMF). | | UE and the RRC. |
| Scenario | PDU Set QoS is | The CN | The RAN | The RAN guarantees |
| 2 | absent when a | determines uplink | receives | PDU Set QoS at least |
| | QoS flow is | PDU Set QoS | PDU Set | for uplink. |
| | established. | handling based on | QoS from | |
| | The UE requests | a request of the | the SMF. | |
| | the SMF for | UE. | | |
| | uplink PDU Set | | | |
| | based handling. | | | |
| Scenario | PDU Set QoS is | The CN | The RAN | The RAN guarantees |
| 3 | absent when a | determines uplink | receives | PDU Set QoS at least |
| | QoS flow is | PDU Set QoS | PDU Set | for uplink. |
| | established. | handling based on | QoS from | |
| | The UE requests | a request of the | the SMF. | |
| | the RAN for | RAN. | | |
| | uplink PDU Set | | | |
| | based handling. | | | |
| | The RAN | | | |
| | initiates a request | | | |
| | to the CN based | | | |
| | on the request of | | | |
| | the UE. | | | |
| Scenario | PDU Set QoS is | | | |
| 4 | absent when a | | | |
| | QoS flow is | | | |
| | established. | | | |
| | The RAN rejects | | | |
| | the request of the | | | |
| | UE. | | | |

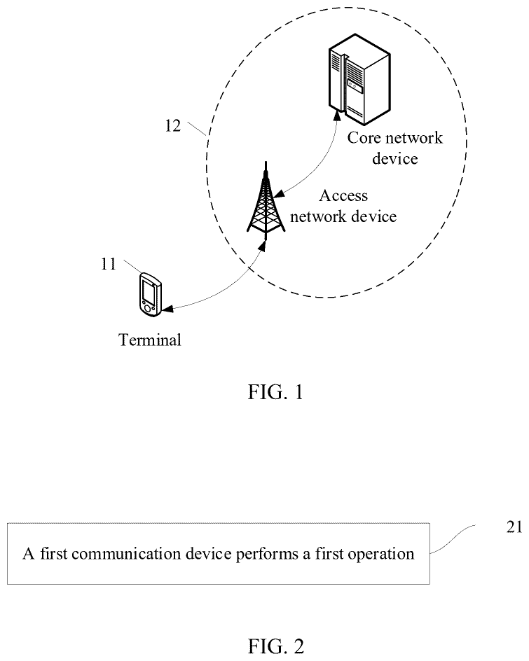

FIG. 1 is a block diagram of a wireless communication system to which the embodiments of this application are applicable. The wireless communication system includes a terminal 11 and a network-side device 12. The terminal 11 may be a terminal-side device such as a mobile phone, a tablet computer, a laptop computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, flight vehicle, Vehicle User Equipment (VUE), ship equipment, Pedestrian User Equipment (PUE), a smart home device (a home device with wireless communication function, such as a refrigerator, a television, a washing machine, or a furniture), a game console, a Personal Computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart strap, smart clothing, and the like. The vehicle user equipment may alternatively be referred to as a vehicle-mounted terminal, a vehicle-mounted controller, a vehicle-mounted module, a vehicle-mounted component, a vehicle-mounted chip, or vehicle-mounted unit. It should be noted that the terminal 11 is not limited to any specific type in the embodiments of this application. The network-side device 12 may include an access network device or a core network device, where the access network device may also be referred to as a Radio Access Network (RAN), a radio access network function, or a radio access network unit. The access network device may include a base station, a Wireless Local Area Network (WLAN) Access Point (AP), a Wireless Fidelity (WiFi) node, or the like. The base station may be referred to as a Node B (NB), an Evolved Node B (eNB), a next generation Node B (gNB), a New Radio Node B (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a Home Node B (HNB), a Home evolved Node B (HeNB), a Transmission Reception Point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that in the embodiments of this application, only the core network device in the NR system is introduced as an example, and the specific type of the core network device is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that in the embodiments of this application, only the core network device in the NR system is introduced as an example, and the specific type of the core network device is not limited.

In some embodiments, obtaining may be understood as acquiring from configuration, receiving, obtaining through receiving upon a request, obtaining through self-learning, obtaining through deduction based on non-received information, or obtaining through processing received information, which may be determined according to actual needs. This is not limited in the embodiments of this application. For example, when specific capability indication information transmitted by a device is not received, it can be deduced that the device does not support the capability.

In some embodiments, transmitting may include broadcasting, broadcasting through a system message, or returning a response after receiving the request.

In an optional embodiment of this application, the communication device may include at least one of the following: a communication network element and a terminal.

In an implementation of this application, the communications network element may include at least one of the following: a core network element and a radio-access network element.

In the embodiments of this application, a core network element may include, but is not limited to, at least one of the following: a core network device, a core network node, a core network function, a core network element, a Mobility Management Entity (MME), an Access Management Function (AMF), a Session Management Function (SMF), a User Plane Function (UPF), a Serving Gateway (SGW), a Packet Data Network Gateway (PDN-GW), a Policy Control Function (PCF), a Policy and Charging Rules Function (PCRF), a Serving GPRS Support Node (SGSN), a Gateway GPRS Support Node (GGSN), and an Application Function (AF).

In the embodiments of this application, a RAN network element may include, but is not limited to, at least one of the following: a radio access networks device, a radio access network node, a radio access network function, a radio access network unit, a 3GPP radio access network, a non-3GPP radio access network, a Centralized Unit (CU), a Distributed Unit (DU), a Base Station, an evolved NodeB (eNB), a 5G base station (gNB), a Radio Network Controller (RNC), a NodeB, a non-3GPP Interworking Function (N3IWF), an Access Controller (AC) node, an Access Point (AP) device, a Wireless Local Area Network (WLAN) node, or an N3IWF.

Abase station may be a BTS (Base Transceiver Station) in GSM or CDMA, or may be a NodeB in WCDMA, or may be an evolved NodeB (eNB or e-NodeB, evolutional Node B) in LTE or a 5G NodeB (gNB), which is not limited in the embodiments of this application.

In an implementation of this application, UE may include one of the following: a terminal device, a terminal device and a card, and a card.

In an implementation of this application, the card may include one of the following: a SIM card, a USIM card, and an eSIM.

In an implementation of this application, the terminal may include at least one of the following: a relay supporting the terminal function and a terminal supporting the relay function. The terminal may also be referred to as a terminal device or User Equipment (UE). The terminal may be a terminal-side device such as a mobile phone, a tablet computer, a laptop computer, a Personal Digital Assistant (PDA), a Mobile Internet Device (MID), a wearable device, or an in-vehicle device. It should be noted that a specific type of the terminal is not limited in the embodiments of this application.

In an implementation of this application, support includes one of the following: being applicable and being enabled.

In an implementation of this application, being applicable can also be referred to as one of the following: being used, adopted, executed, and performed.

In some embodiments, a first object includes at least one of the following: a first radio bearer (such as a DRB or a logical channel) and a first QoS flow.

In an implementation, the first QoS flow maps to a QoS flow of the first radio bearer.

In an implementation, the first radio bearer is a radio bearer mapped by the first QoS flow.

In an implementation, at least one of a first request, a first response, a second request, a second response, requested PDU Set QoS, PDU Set QoS, second information, third information, fourth information, and fifth information may be information corresponding to the first object.

In some implementations, the second object includes at least one of the following: a terminal and a first object.

In some implementations, the third object includes at least one of the following: a first QoS flow and a first rule (such as a PCC rule).

In an implementation, the first rule is a rule (such as a PCC rule) bound to the first QoS flow.

In an implementation, the first QoS flow is a QoS flow bound to the first rule.

In an implementation, at least one of a first request, a first response, requested PDU Set QoS, PDU Set QoS, second information, third information, fourth information, and fifth information may be information corresponding to the third object.

In an implementation, a first request corresponding to the N-th object is used to request PDU Set based handling for the N-th object. In an implementation, a second request corresponding to the N-th object is used to request PDU Set based handling for the N-th object.

In an implementation, second information corresponding to the N-th object is used to indicate at least one of the following: applying or not applying PDU Set importance to the N-th object, and applying or not applying PDU Set importance-based handling to the N-th object.

In an implementation, third information corresponding to the N-th object is used to indicate at least one of the following: applying PDU Set based handling to the N-th object, and applying PDU Set based handling to uplink of the N-th object.

In an implementation, fourth information corresponding to the N-th object can be used to indicate at least one of the following: PDU Set based handling is supported for the N-th object, and PDU Set based handling is supported in uplink of the N-th object.

In an implementation, fifth information corresponding to the N-th object is used to indicate one of the following: information that PDU Set based handling is supported in uplink of the N-th object, and information that PDU Set based handling is not supported in uplink of the N-th object.

The N-th object includes at least one of the following: a first object, a second object, a third object, a first QoS flow, and a first radio bearer.

In an implementation of this application, requesting PDU Set based handling includes at least one of the following: requesting PDU Set based handling for uplink, and requesting PDU Set based handling for downlink.

In an implementation of this application, the applying or not applying PDU Set importance includes at least one of the following: applying or not applying PDU Set importance to uplink, and applying or not applying PDU Set importance to downlink.

In an implementation of this application, supporting PDU Set based handling includes at least one of the following: supporting PDU Set based handling in uplink, and supporting PDU Set based handling in downlink.

In an implementation of this application, the not supporting PDU Set based handling includes at least one of the following: not supporting PDU Set based handling in uplink, and not supporting PDU Set based handling in downlink.

In an implementation of this application, the applying PDU Set based handling includes at least one of the following: applying PDU Set based handling in uplink, and applying PDU Set based handling in downlink.

In an implementation of this application, the not applying PDU Set based handling includes at least one of the following: not applying PDU Set based handling in uplink and not applying PDU Set based handling in downlink.

The PDU Set based handling includes at least one of the following:
handling a data packet based on a PDU Set granularity;
applying PDU Set QoS;
PDU Set QoS-based handling;
applying PDU Set importance; and
PDU Set importance-based handling.

In an implementation of this application, the applying PDU Set QoS includes at least one of the following: using PDU Set-level QoS-based handling, using data packet-level handling, using PSDB to replace PDB, and using PSER to replace PER.

In an implementation of this application, the not applying PDU Set QoS includes at least one of the following: not using PDU Set-level QoS-based handling, not using data packet-level handling, not using PSDB to replace PDB, and not using PSER to replace PER.

In an implementation of this application, the applying PDU Set based handling includes applying PDU Set QoS.

The applying PDU Set QoS includes applying at least one of the following: applying PDU Set QoS, not applying data packet-level QoS, applying PSDB, applying PSER, and applying PSIHI. Not applying PDU Set QoS includes at least one of the following: not applying PDU Set QoS, applying data packet-level QoS, not applying PSDB, not applying PSER, not applying PSIHI, applying PDB, and applying PER.

The not applying PSDB includes at least one of the following: not using PSDB to replace PDB, and using PDB.

The not using PSER includes at least one of the following: not using PSER to replace PDB, and using PER.

In an implementation of this application, the not applying PDU Set based handling to uplink or not applying PDU Set QoS to uplink includes performing at least one of the following on uplink of the first object: not applying PDU Set based handling, not using PDU Set-level QoS-based handling, using data packet-level handling, not using PSDB to replace PDB, and not using PSER to replace PER.

The not applying PSDB to uplink includes one of the following: not using PSDB to replace PDB for uplink, and using PDB for uplink.

The not applying PSER to uplink includes one of the following: not using PSER to replace PER for uplink, and using PER for uplink.

The applying PSDB to uplink includes one of the following: using PSDB to replace PDB for uplink, and using PDB for uplink.

The applying PSER to uplink includes one of the following: using PSER to replace PER for uplink, and using PER for uplink.

The not applying PSDB to downlink includes one of the following: not using PSDB to replace PDB for downlink, and using PDB for downlink.

The not applying PSER to downlink includes one of the following: not using PSER to replace PER for downlink, and using PER for downlink.

The applying PSDB to downlink includes one of the following: using PSDB to replace PDB for downlink, and using PDB for downlink.

The applying PSER to downlink includes one of the following: using PSER to replace PER for downlink, and using PER for downlink.

It is easy to understand that even if the first object has at least one of PDU Set QoS, PDU Set importance, and second information, at least one of the following needs to be performed on uplink of the first object: not using PDU Set based handling (including not applying at least one of PDU Set QoS, PDU Set importance, and the second information), using data packet-level handling (for example, at least one of PER and PDB), not using PSDB to replace PDB, and not using PSER to replace PER.

In an implementation of this application, the PDU Set QoS includes at least one of the following: PDU Set Error Rate (PSER), PDU Set Delay Budget (PSDB), and PDU Set Integrated Handling Information (PSIHI).

PSIHI can be used to request PDU Set integrated handling.

In another implementation, the PDU Set QoS further includes PDU Set importance. That is, PDU Set importance may or may not be PDU Set QoS.

In an implementation of this application, the applying PDU Set QoS includes performing at least one of PDU Set-level QoS guarantee, scheduling, time-frequency resource configuration, and the like for data based on PDU Set QoS.

The applying PDU Set based handling to uplink by a second communication device (RAN) includes: handling uplink data based on a PDU Set parameter (including at least one of PDU Set QoS and PDU Set importance), for example, scheduling, resource allocation, or configuration of a packet discarding timer.

In an implementation of this application, the PDU Set importance-based handling includes packet discarding based on PDU Set importance.

In an implementation of this application, the PDU Set packet discarding includes at least one of the following: packet discarding based on PDU Set importance, and PDU Set integrated packet discarding.

In an implementation of this application, the applying PDU Set importance-based handling includes: discarding a PDU Set based on PDU Set importance in a case of congestion. For example, discarding is performed in ascending order of importance.

In an implementation of this application, the PDU Set QoS is used to implicitly indicate at least one of the following: applying PDU Set QoS to downlink, and applying PDU Set QoS-based handling to downlink.

In an implementation of this application, the applying PDU Set importance implicitly indicates: applying PDU Set importance to downlink.

In an implementation of this application, the applying PDU Set importance-based handling implicitly indicates: applying PDU Set importance-based handling to downlink.

In this case, it is easy to understand that the third information may merely indicate applying PDU Set based handling to uplink.

In this case, it is easy to understand that the fourth information may merely indicate that PDU Set based handling is supported in uplink.

In an implementation of this application, the applying or not applying PDU Set importance includes applying or not applying PDU Set importance to at least one of uplink and downlink.

In an implementation of this application, the applying or not applying PDU Set importance-based handling includes applying or not applying PDU Set importance-based handling to at least one of uplink and downlink.

The following describes in detail an information processing method, an information processing apparatus, a communication device, and a readable storage medium provided in the embodiments of this application through some embodiments and application scenarios thereof with reference to the accompanying drawings.

Referring to FIG. 2, an embodiment of this application provides an information processing method, applied to a first communication device. The first communication device includes, but is not limited to, one of the following: a terminal or an Application Function (AF), and the method includes the following steps.

Step 21: The first communication device performs a first operation, where the first operation includes at least one of the following:
sending at least one of the following to a second communication device: a second request and first capability information; and
sending at least one of the following to a core network element: a first request, the first capability information, and requested PDU Set QoS.

The first request or the second request is used to request PDU Set based handling; and
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal.

The second communication device includes but is not limited to a RAN network element, such as a base station.

In an implementation, the requesting PDU Set based handling includes requesting PDU Set based handling for at least one of uplink and downlink.

In an implementation, the first communication device is a terminal, and requesting PDU Set based handling may include requesting PDU Set based handling for uplink. It is easy to understand that whether PDU Set based handling is requested for uplink data depends on the terminal and an application on the terminal. However, it is not excluded that the terminal requests PDU Set based handling for downlink. Because downlink handling depends on PDU Set QoS, protocol information (such as Real-time Transport Protocol (RTP) and Moving Picture Expert Group (MPEG)), such information can also be known by the terminal.

In a case that the first communication device is an AF, the AF may request PDU Set based handling for at least one of uplink and downlink.

In an implementation, the first communication device sends a first request to a core network element (such as a third communication device, an SMF, an AMF, or a PCF).

In some implementations, at least one of the first request, a first response, a second request, a second response, requested PDU Set QoS, PDU Set QoS, second information, third information, and fourth information may be information corresponding to a first object.

In an implementation, the first object includes a first radio bearer (such as a DRB or a logical information) and a first QoS flow.

In an implementation, the PDU Set based handling includes at least one of the following:
handling a data packet based on a PDU Set granularity;
applying PDU Set QoS;
PDU Set QoS-based handling;
applying PDU Set importance; and
PDU Set importance-based handling.

In an implementation, a first request or a second request corresponding to the first object is used for requesting to apply PDU Set based handling to the first object (including requesting PDU Set based handling for at least one of uplink and downlink of the first object).

In an implementation, the applying PDU Set importance-based handling includes: discarding a PDU Set based on PDU Set importance in a case of congestion. For example, discarding is performed in ascending order of importance.

In some implementations, the first operation further includes:
receiving fourth information, and determining, based on the fourth information, whether to send or not to send at least one of the following: the first request, the requested PDU Set QoS, and the second request;
or
after the step of sending the first request, receiving at least one of a first response, PDU Set QoS, second information, third information, and fourth information, and determining, based on at least one of the first response, the PDU Set QoS, the second information, the third information, and the fourth information, whether to send or not to send the second request.

The second information is used for indicating at least one of the following: applying or not applying PDU Set importance, and applying or not applying PDU Set importance-based handling.

The third information is used for indicating at least one of the following: applying or not applying PDU Set based handling, applying or not applying PDU Set based handling to uplink, and applying or not applying PDU Set based handling to downlink.

The fourth information is used for indicating at least one of the following: supporting or not supporting PDU Set based handling, supporting or not supporting PDU Set based handling in uplink, and supporting or not supporting PDU Set based handling in downlink.

The first response includes information for accepting or rejecting a first request.

In an implementation, at least one of the PDU Set QoS, the second information, the third information, and the fourth information is received from at least one of the second communication device (such as the RAN) and the third communication device (such as the SMF).

In an implementation, the PDU Set QoS is PDU Set QoS received from the core network element after the first communication device sends the requested PDU Set QoS.

In some implementations, at least one of the PDU Set QoS, the second information, the third information, and the fourth information can be received from one of the following: the core network element, the second communication device, and the third communication device.

In an implementation, the first operation further includes: after the step of sending the second request, receiving at least one of the following: third information, fourth information, and a second response.

In an implementation, the third information, the fourth information, and the second response are received from the second communication device (such as a RAN network element).

In an implementation, the sending at least one of the following to a core network element: a first request, first capability information, and requested PDU Set QoS includes: in a case that a first condition is met, sending at least one of the following: the first request, the first capability information, and the requested PDU Set QoS.

The meeting the first condition includes at least one of the following:
a requirement for applying PDU Set based handling has been generated or obtained;
it is determined that PDU Set based handling is supported, or it is determined that PDU Set based handling is supported in uplink;
fourth information has been obtained, and the fourth information indicates at least one of the following: supporting PDU Set based handling, or indicating supporting PDU Set based handling in uplink; and
PDU Set based handling is supported for the terminal, or uplink PDU Set based handling is supported for the terminal.

In some implementations, the second object includes at least one of the following: a terminal and a first object.

In some implementations, the determining that PDU Set based handling is supported includes determining that PDU Set based handling is supported for the second object.

In some implementations, the determining that PDU Set based handling is supported in uplink includes determining that PDU Set based handling is supported in uplink of the second object.

In some implementations, the determining to apply PDU Set based handling includes determining to apply PDU Set based handling to the second object.

In some implementations, the determining to apply PDU Set based handling to uplink includes determining to apply PDU Set based handling to uplink of the second object.

In an implementation, the fourth information (for example, information indicating that PDU Set based handling is supported) is received from the core network element or the RAN network element.

In an implementation, the first communication device locally configures or obtains, from an upper-layer application, a requirement for applying PDU Set based handling to at least one of uplink and downlink.

In another implementation, the first communication device obtains the third information from the CN or the RAN.

In an implementation, the information indicating that PDU Set based handling is supported includes: information indicating that PDU Set based handling is supported in at least one of uplink and downlink.

In an implementation, the core network element includes at least one of the following: an AMF, an SMF, and a PCF. After receiving the first request, the AMF forwards the first request to the SMF.

In some implementations, the sending the second request to the second communication device includes:
in a case that a second condition is met, sending the second request to the second communication device.

The meeting the second condition includes at least one of the following:
a requirement for applying PDU Set based handling has been generated or obtained;
a first response has been obtained, and the first response includes information for accepting a first request;
fourth information has been obtained, and the fourth information indicates at least one of the following: supporting PDU Set based handling, or indicating supporting PDU Set based handling in uplink;
PDU Set QoS has been obtained;
second information has been obtained; and
third information has been obtained, and the third information indicates at least one of the following: applying PDU Set based handling, and applying PDU Set based handling to uplink.

In some implementations, the first response may be received from one of the following: the core network element, the third communication device, and the AMF.

In some implementations, the second response may be received from the second communication device. The sending the second request to the second communication device in a case that the second condition is met includes: after the first communication device sends the first request to the third communication device, sending the second request to the second communication device in a case that the second condition is met.

In an implementation, the first communication device locally configures or obtains, from an upper-layer application, a requirement for applying PDU Set based handling to at least one of uplink and downlink.

In another implementation, the first communication device obtains the third information from the CN or the RAN.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

Referring to FIG. 3, an embodiment of this application provides an information processing method, applied to a second communication device. The second communication device includes, but is not limited to, a radio access network element (such as a base station), and the method includes:

Step 31: The second communication device performs a second operation, where the second operation includes at least one of the following:
determining to apply or not to apply PDU Set based handling, or determining to apply or not to apply PDU Set based handling to uplink;
determining that PDU Set based handling is supported or not supported, or determining that PDU Set based handling is supported or not supported to uplink;
receiving at least one of the following sent by a first communication device: a second request and first capability information;
sending at least one of the following to a core network element based on at least one of the second request and the first capability information: a first request, the first capability information, and fifth information, where the fifth information is used for indicating one of the following: information that PDU Set based handling is supported in uplink and information that PDU Set based handling is not supported in uplink;
receiving first information sent by the core network element; and
performing a first sub-operation of the second operation based on at least one of the first information, the first capability information, and the second request.

The first sub-operation of the second operation includes at least one of the following:
accepting the second request or rejecting the second request;
determining to apply or not to apply PDU Set based handling, or determining to apply or not to apply PDU Set based handling to uplink;
sending at least one of the following to the first communication device: third information, fourth information, and a second response; and
sending fifth information to a third communication device.

The first request or the second request is used to request PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the first information includes at least one of the following: PDU Set QoS, second information, the third information, the fourth information, and a first response;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the first response includes information for accepting or rejecting a first request; and
the second response includes information for accepting or rejecting a second request.

In an implementation, the information indicating that PDU Set based handling is supported includes: information indicating that PDU Set based handling is supported in at least one of uplink and downlink.

In an implementation, the information indicating that PDU Set based handling is supported includes: information indicating that PDU Set based handling is supported in uplink.

Applying PDU Set based handling to uplink by the second communication device includes: handling uplink data based on a PDU Set parameter (including at least one of PDU Set QoS and PDU Set importance), for example, scheduling, resource allocation, or configuration of a packet discarding timer.

In some implementations, requesting PDU Set based handling includes requesting PDU Set based handling for at least one of uplink and downlink.

In an implementation, the PDU Set QoS is used to implicitly indicate one of the following: applying PDU Set QoS to downlink, and applying PDU Set QoS-based handling to downlink.

In an implementation, the applying PDU Set importance implicitly indicates one of the following: applying PDU Set importance to downlink.

In an implementation, the applying PDU Set importance-based handling implicitly indicates: applying PDU Set importance-based handling to downlink.

In this case, it is easy to understand that the third information may merely indicate applying PDU Set based handling to uplink.

In this case, it is easy to understand that the fourth information may merely indicate that PDU Set based handling is supported in uplink.

In an implementation, applying or not applying PDU Set importance includes applying or not applying PDU Set importance to at least one of uplink and downlink.

In an implementation, applying or not applying PDU Set importance-based handling includes applying or not applying PDU Set importance-based handling to at least one of uplink and downlink.

In some implementations, the sending the first request to the core network element based on at least one of the second request and the first capability information includes:
in a case that a third condition is met, sending, by the second communication device, the first request to the core network element.

The meeting the third condition includes at least one of the following:
it is determined that PDU Set based handling is supported, or it is determined that PDU Set based handling is supported in uplink;
the second request has been obtained;
PDU Set based handling is supported for the terminal, or uplink PDU Set based handling is supported for the terminal;
PDU Set based handling is not applied to uplink of a first object, or PDU Set based handling is not applied to the first object;
it is unclear whether PDU Set based handling is supported for the first object, or it is unclear whether PDU Set based handling is supported in uplink of the first object, or PDU Set based handling is supported for the first object, or PDU Set based handling is supported in uplink of the first object;
at least one of the following corresponding to the first object is absent: PDU Set QoS, second information, third information, fourth information, and a first response; and
the first object includes at least one of the following: a first radio bearer and a first QoS flow.

In an implementation, the first QoS flow maps to a QoS flow of the first radio bearer.

In an implementation, the first radio bearer is a radio bearer mapped by the first QoS flow.

In an implementation, the second communication device receives and obtains the fourth information from the core network element, and based on the fourth information, determines that PDU Set based handling is supported, or determines that PDU Set based handling is supported in uplink. For example, the information is obtained before at least one of the second request and the first capability information is received. However, the second communication device sends the first request to the core network element because “a PDU Set based handling related parameter (such as PDU Set QoS and second information) corresponding to the first object is absent”.

In a case that “at least one of the following corresponding to the first object is absent: PDU Set QoS, second information, third information, fourth information, and a first response”, in an implementation, the second communication device sends the first request to the core network element. In another implementation, the second communication device rejects the second request.

In some implementations, the second operation includes:
after the step of sending the first request to the core network element, receiving first information sent by the core network element; and
performing a first sub-operation of the second operation based on at least one of the first information, the first capability information, and the second request.

In some implementations, the first sub-operation of the second operation includes:
in a case that a fourth condition is met, performing, by the second communication device, at least one of the following:
accepting the second request;
sending at least one of third information, fourth information, and a second response to the first communication device; and
sending, to the third communication device, fifth information indicating that PDU Set based handling is supported in uplink.

The fourth information indicates at least one of the following: supporting PDU Set based handling, or supporting PDU Set based handling in uplink.

The third information indicates at least one of the following: applying PDU Set based handling, or applying PDU Set based handling to uplink.

The second response includes information for accepting the second request.

The meeting the fourth condition includes at least one of the following:
it is determined to apply PDU Set based handling, or apply PDU Set based handling to uplink;
it is determined that PDU Set based handling is supported or PDU Set based handling is supported in uplink;
PDU Set QoS corresponding to a first object is present;
second information corresponding to the first object is present, and the second information indicates one of the following: applying PDU Set importance, or applying PDU Set importance-based handling;
third information corresponding to the first object is present, and the third information indicates one of the following: applying PDU Set based handling, or applying PDU Set based handling to uplink;
fourth information corresponding to the first object is present, and the fourth information indicates one of the following: supporting PDU Set based handling, or supporting PDU Set based handling in uplink;
a first response corresponding to the first object is present, and the first response includes information for accepting a first request; and
first capability information is present, and the first capability information indicates one of the following: PDU Set based handling is supported for the terminal, or uplink PDU Set based handling is supported for the terminal.

The first object includes at least one of the following: a first radio bearer and a first QoS flow.

In an implementation, the second request is a second request corresponding to the first object.

In some implementations, the second object includes at least one of the following: a terminal and a first object.

In some implementations, the determining that PDU Set based handling is supported includes determining that PDU Set based handling is supported for the second object.

In some implementations, the determining that PDU Set based handling is supported in uplink includes determining that PDU Set based handling is supported in uplink of the second object.

In some implementations, the determining to apply PDU Set based handling includes determining to apply PDU Set based handling to the second object.

In some implementations, the determining to apply PDU Set based handling to uplink includes determining to apply PDU Set based handling to uplink of the second object.

In an implementation, it may be determined, based on the first capability information, that PDU Set based handling is supported for the terminal, or it may be determined that PDU Set based handling is supported for the terminal in uplink.

In another implementation, based on the third information corresponding to the first object, it may be determined to apply PDU Set based handling to the first object, or it may be determined to apply PDU Set based handling to uplink of the first object.

In another implementation, according to the fourth information corresponding to the first object, it may be determined that PDU Set based handling is supported for the first object, or it may be determined that PDU Set based handling is supported in uplink of the first object.

In some implementations, the meeting the fourth condition includes:
based on at least one of the first capability information and the first information, it is determined that the fourth condition is met.

In an implementation, the first information may be first information corresponding to the first object.

In some implementations, the first sub-operation of the second operation includes:
in a case that a fifth condition is met, performing, by the second communication device, at least one of the following:
rejecting the second request;
sending at least one of third information, fourth information, and a second response to the first communication device; and
sending, to the third communication device, fifth information indicating that PDU Set based handling is not supported in uplink.

The fourth information indicates at least one of the following: not supporting PDU Set based handling, or indicating not supporting PDU Set based handling in uplink.

The third information indicates at least one of the following: not applying PDU Set based handling, or not applying PDU Set based handling to uplink.

The second response includes information for rejecting the first request.

The meeting the fifth condition includes at least one of the following:
it is determined that PDU Set based handling is not supported or PDU Set based handling is not supported in uplink;
it is determined not to apply PDU Set based handling, or not to apply PDU Set based handling to uplink;
at least one of PDU Set QoS, second information, third information, and fourth information that are corresponding to the first object is absent;
second information corresponding to the first object is present, and the second information indicates one of the following: not applying PDU Set importance, or not applying PDU Set importance-based handling;
third information corresponding to the first object is present, and the third information indicates one of the following: not applying PDU Set based handling, or not applying PDU Set based handling to uplink;
fourth information corresponding to the first object is present, and the fourth information indicates one of the following: not supporting PDU Set based handling, or not supporting PDU Set based handling in uplink;
a first response corresponding to the first object is present, and the first response includes information for rejecting a first request; and
first capability information is present, and the first capability information indicates one of the following: PDU Set based handling is not supported for the terminal, or uplink PDU Set based handling is not supported for the terminal.

The first object includes at least one of the following: a first radio bearer and a first QoS flow.

The second object includes at least one of the following: a terminal and a first object.

In some implementations, the determining that PDU Set based handling is not supported in uplink includes determining that PDU Set based handling is not supported in uplink of the second object.

In some implementations, the determining not to apply PDU Set based handling includes determining not to apply PDU Set based handling to the second object.

In some implementations, the determining not to apply PDU Set based handling to uplink includes determining not to apply PDU Set based handling to uplink of the second object.

In an implementation, it may be determined, based on the first capability information, that PDU Set based handling is not supported for the terminal, or it may be determined that PDU Set based handling is not supported for the terminal in uplink.

In another implementation, based on the third information corresponding to the first object, it may be determined not to apply PDU Set based handling to the first object, or it may be determined not to apply PDU Set based handling to uplink of the first object.

In another implementation, according to the fourth information corresponding to the first object, it may be determined that PDU Set based handling is not supported for the first object, or it may be determined that PDU Set based handling is not supported in uplink of the first object.

In some implementations, the meeting the fifth condition includes: based on at least one of the first capability information and the first information, it is determined that the fifth condition is met.

In some implementations, the second operation includes:
in a case that a sixth condition is met, performing, by the second communication device, the following:
determining to apply PDU Set based handling, or determining to apply PDU Set based handling to uplink; and
sending third information to the first communication device.

The third information indicates at least one of the following: applying PDU Set based handling, or applying PDU Set based handling to uplink.

The meeting the sixth condition includes at least one of the following:
it is determined that PDU Set based handling is supported, or it is determined that PDU Set based handling is supported in uplink;
a second request has been received, and the second request is able to be accepted;
PDU Set QoS corresponding to a first object is present;
second information corresponding to the first object is present, and the second information indicates one of the following: applying PDU Set importance, or applying PDU Set importance-based handling;
third information corresponding to the first object is present, and the third information indicates one of the following: applying PDU Set based handling, or applying PDU Set based handling to uplink;
fourth information corresponding to the first object is present, and the fourth information indicates one of the following: supporting PDU Set based handling, or supporting PDU Set based handling in uplink;
a first response corresponding to the first object is present, and the first response includes information for accepting a first request; and
first capability information is present, and the first capability information indicates one of the following: PDU Set based handling is supported for the terminal, or uplink PDU Set based handling is supported for the terminal.

In some implementations, the second object includes at least one of the following: a terminal and a first object.

In some implementations, the determining that PDU Set based handling is supported includes determining that PDU Set based handling is supported for the second object.

In some implementations, the determining that PDU Set based handling is supported in uplink includes determining that PDU Set based handling is supported in uplink of the second object.

In some implementations, the determining to apply PDU Set based handling includes determining to apply PDU Set based handling to the second object.

In some implementations, the determining to apply PDU Set based handling to uplink includes determining to apply PDU Set based handling to uplink of the second object.

In an implementation, it may be determined, based on the first capability information, that PDU Set based handling is supported for the terminal, or it may be determined that PDU Set based handling is supported for the terminal in uplink.

In another implementation, based on the third information corresponding to the first object, it may be determined to apply PDU Set based handling to the first object, or it may be determined to apply PDU Set based handling to uplink of the first object.

In another implementation, based on the fourth information corresponding to the first object, it may be determined that PDU Set based handling is supported for the first object, or it may be determined that PDU Set based handling is supported in uplink of the first object.

First capability information is present, and the first capability information indicates one of the following: PDU Set based handling is supported for the terminal, or uplink PDU Set based handling is supported for the terminal.

In some implementations, the second operation includes:
in a case that a seventh condition is met, performing, by the second communication device, at least one of the following:
determining not to apply PDU Set based handling, or not to apply PDU Set based handling to uplink; and
sending third information to the first communication device.

The third information indicates at least one of the following: not applying PDU Set based handling, or not applying PDU Set based handling to uplink.

The meeting the seventh condition includes at least one of the following:
it is determined that PDU Set based handling is not supported, or it is determined that PDU Set based handling is not supported in uplink;
a second request has been rejected, or a corresponding first request has been rejected, or a second request has not been received;
at least one of PDU Set QoS, second information, third information, and fourth information that are corresponding to the first object is absent;
second information corresponding to the first object is present, and the second information indicates one of the following: not applying PDU Set importance, or not applying PDU Set importance-based handling;
third information corresponding to the first object is present, and the third information indicates one of the following: not applying PDU Set based handling, or not applying PDU Set based handling to uplink;
fourth information corresponding to the first object is present, and the fourth information indicates one of the following: not supporting PDU Set based handling, or not supporting PDU Set based handling in uplink;
a first response corresponding to the first object is present, and the first response includes information for rejecting a first request; and
first capability information is present, and the first capability information indicates one of the following: PDU Set based handling is not supported for the terminal, or uplink PDU Set based handling is not supported for the terminal.

When the second communication device obtains at least one of PDU Set QoS and PDU Set importance, and the seventh condition is met, the second communication device applies PDU Set based handling only to downlink, but not applying PDU Set based handling to uplink (that is, not applying at least one of PDU Set QoS and PDU Set importance).

In some implementations, the second object includes at least one of the following: a terminal and a first object.

In some implementations, the determining that PDU Set based handling is not supported in uplink includes determining that PDU Set based handling is not supported in uplink of the second object.

In some implementations, the determining not to apply PDU Set based handling includes determining not to apply PDU Set based handling to the second object.

In some implementations, the determining not to apply PDU Set based handling to uplink includes determining not to apply PDU Set based handling to uplink of the second object.

In an implementation, it may be determined, based on the first capability information, that PDU Set based handling is not supported for the terminal, or it may be determined that PDU Set based handling is not supported for the terminal in uplink.

In another implementation, based on the third information corresponding to the first object, it may be determined not to apply PDU Set based handling to the first object, or it may be determined not to apply PDU Set based handling to uplink of the first object.

In another implementation, according to the fourth information corresponding to the first object, it may be determined that PDU Set based handling is not supported for the first object, or it may be determined that PDU Set based handling is not supported in uplink of the first object.

In some implementations, the second operation includes:
in a case that an eighth condition is met, performing, by the second communication device, at least one of the following:
determining that PDU Set based handling is not supported or PDU Set based handling is not supported in uplink;
sending fourth information to the first communication device; and
sending, to the third communication device, fifth information indicating that PDU Set based handling is not supported in uplink.

The fourth information indicates at least one of the following: supporting PDU Set based handling, or supporting PDU Set based handling in uplink.

The meeting the eighth condition includes at least one of the following:
it is determined not to apply PDU Set based handling, or it is determined not to apply uplink PDU Set based handling;
at least one of PDU Set QoS, second information, third information, and fourth information that are corresponding to the first object is absent;
second information corresponding to the first object is present, and the second information indicates one of the following: not applying PDU Set importance, or not applying PDU Set importance-based handling;
third information corresponding to the first object is present, and the third information indicates one of the following: not applying PDU Set based handling, or not applying PDU Set based handling to uplink;
fourth information corresponding to the first object is present, and the fourth information indicates one of the following: not supporting PDU Set based handling, or not supporting PDU Set based handling in uplink;
a first response corresponding to the first object is present, and the first response includes information for rejecting a first request; and
first capability information is present, and the first capability information indicates one of the following: PDU Set based handling is not supported for the terminal, or uplink PDU Set based handling is not supported for the terminal.

In some implementations, the second operation includes:
in a case that a ninth condition is met, performing, by the second communication device, the following:
determining that PDU Set based handling is supported, or determining that PDU Set based handling is supported in uplink;
sending fourth information to the first communication device; and
sending, to the third communication device, fifth information indicating that PDU Set based handling is supported in uplink.

The fourth information indicates at least one of the following: supporting PDU Set based handling, or supporting PDU Set based handling in uplink.

The meeting the ninth condition includes at least one of the following:
it is determined to apply PDU Set based handling, or it is determined to apply uplink PDU Set based handling;
PDU Set QoS corresponding to a first object is present;
second information corresponding to the first object is present, and the second information indicates one of the following: applying PDU Set importance, or applying PDU Set importance-based handling;
third information corresponding to the first object is present, and the third information indicates one of the following: applying PDU Set based handling, or applying PDU Set based handling to uplink;
fourth information corresponding to the first object is present, and the fourth information indicates one of the following: supporting PDU Set based handling, or supporting PDU Set based handling in uplink;
a first response corresponding to the first object is present, and the first response includes information for accepting a first request; and
first capability information is present, and the first capability information indicates one of the following: PDU Set based handling is supported for the terminal, or uplink PDU Set based handling is supported for the terminal.

In some implementations, the not applying PDU Set based handling to uplink includes at least one of the following:
not handling a data packet for uplink based on a data packet set granularity;
not applying PDU Set QoS to uplink;
not performing PDU Set QoS-based handling for uplink;
not applying PDU Set importance to uplink; and
not performing PDU Set importance-based handling for uplink.

The not applying PDU Set QoS to uplink includes at least one of the following: not applying PDU Set QoS, applying data packet-level QoS, not applying PDU Set delay budget PSDB, not applying PDU Set error rate PSER, not applying PDU Set integrated handling information PSIHI, and not applying PDU Set importance.

In some implementations, the not applying PSDB to uplink includes one of the following: not using PSDB to replace PDB for uplink, and using PDB for uplink; and
the not applying PSER to uplink includes one of the following: not using PSER to replace PER for uplink, and using PER for uplink.

The not applying PDU Set based handling to uplink is, for example, not applying PDU Set based handling to uplink of the first object. The not applying PSDB to uplink further includes applying PSDB to downlink. It is easy to understand that when the second communication device obtains PSDB and information (such as the third information) indicating not to apply PDU Set based handling to uplink, the second communication device may apply PSDB to downlink, but not apply PSDB to uplink.

The not applying PSER to uplink further includes applying PSER to downlink. When the second communication device obtains PSER and information (such as the third information) indicating not to apply PDU Set based handling to uplink, the second communication device may apply PSER to downlink, but not apply PSER to uplink.

The not applying PSIHI to uplink further includes applying PSIHI to downlink. When the second communication device obtains PSIHI and information (such as the third information) indicating not to apply PDU Set based handling to uplink, the second communication device may apply PSIHI to downlink, but not apply PSIHI to uplink.

Even if the first object has at least one of PDU Set QoS, PDU Set importance, and second information, at least one of the following needs to be performed on uplink of the first object: not using PDU Set based handling (including not applying at least one of PDU Set QoS, PDU Set importance, and the second information), using data packet-level handling (for example, at least one of PER and PDB), not using PSDB to replace PDB, and not using PSER to replace PER.

In this embodiment of this application, how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

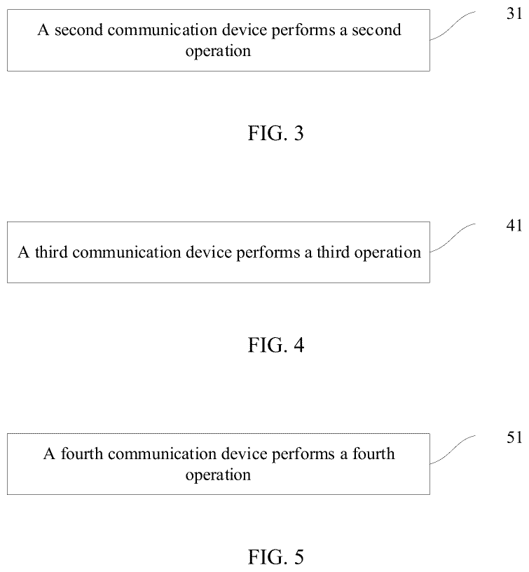

Referring to FIG. 4, an embodiment of this application provides an information processing method, applied to a third communication device. The third communication device includes but is not limited to a core network element (such as an SMF or a PCF), and the method includes the following steps.

Step 41: The third communication device performs a third operation, where the third operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
based on at least one of the requested PDU Set QoS, the first request, the fifth information, and the first capability information, performing a first sub-operation of the third operation, or performing a second sub-operation of the third operation.

The first sub-operation of the third operation includes at least one of the following:
accepting the first request or rejecting the first request;
determining at least one of the PDU Set QoS, the second information, the third information, the fourth information, and a first response; and
sending at least one of the following to at least one of a first communication device and a second communication device: the PDU Set QoS, the second information, the third information, the fourth information, and the first response.

The second sub-operation of the third operation includes at least one of the following:
determining, based on a first request of a first QoS flow, a first request corresponding to a first policy; and
sending at least one of the requested PDU Set QoS, a first request, fifth information, and first capability information to a fourth communication device.

The first request is used to request at least one of the following: PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

In an implementation, the first request is a first request corresponding to a third object (such as a first QoS flow).

The third object includes at least one of the following: such as the first QoS flow and a first rule (such as a PCC rule).

In an implementation, the PDU Set QoS, the second information, the third information, the fourth information, the fifth information, and the first response is information corresponding to the third object.

In some implementations, the third communication device locally configures or receives from a fourth communication device (such as a PCF, a NEF, and an AF) at least one of the following: PDU Set QoS, second information, third information, and fourth information.

In some implementations, at least one of the following is received from at least one of the first communication device (such as UE) and the second communication device (such as a RAN): requested PDU Set QoS, a first request, and first capability information.

In some implementations, the following is received from the second communication device (such as the RAN): fifth information.

In some implementations, at least one of the following is sent to at least one of the first communication device (such as UE) and the second communication device (such as the RAN): PDU Set QoS, second information, third information, fourth information, and a first response.

In an implementation, in a case that a first request is received from the second communication device, at least one of PDU Set QoS, second information, third information, fourth information, and a first response is sent to the second communication device (such as the RAN).

In an implementation, in a case that a first request is received from the first communication device, PDU Set QoS, third information, fourth information, and a first response are sent to the first communication device (such as the UE).

In an implementation, in a case that requested PDU Set QoS is received (for example, from the first communication device), PDU Set QoS is sent to the first communication device (such as the UE). It is easy to understand that the PDU Set QoS in this case is accepted PDU Set QoS.

In another implementation, in a case that the first request is not received, PDU Set QoS, third information, and fourth information can alternatively be sent to the first communication device or the second communication device.

The PDU Set QoS includes at least one of the following: PSDB, PSER, and PSIHI.

In some implementations, the information indicating that PDU Set based handling is supported is used as information for accepting the first request; and the information indicating that PDU Set based handling is not supported is used as information for rejecting the first request.

In some implementations, the third operation includes:
in a case that a tenth condition is met, performing, by the third communication device, at least one of the following:
accepting the first request;
determining to apply PDU Set based handling, or determining to apply PDU Set based handling to uplink; and
sending at least one of PDU Set QoS, second information, third information, and a first response.

The meeting the tenth condition includes at least one of the following:
PDU Set QoS has been obtained or determined;
second information has been obtained or determined, and the second information indicates one of the following: applying PDU Set importance, or applying PDU Set importance-based handling;
PDU Set based handling is supported or uplink PDU Set based handling is supported for the second communication device;
PDU Set based handling is supported or uplink PDU Set based handling is supported for the terminal;
PDU Set based handling is supported or downlink PDU Set based handling is supported for an anchor gateway;
the fifth information indicates information that PDU Set based handling is supported in uplink; and
it is determined that PDU Set based handling is supported or PDU Set based handling is supported in uplink.

The second information indicates at least one of the following: applying PDU Set importance, or applying PDU Set importance-based handling.

The third information indicates one of the following: applying PDU Set based handling, or applying PDU Set based handling to uplink.

The first response includes information for accepting a first request.

In an implementation, at least one of PDU Set QoS (sent by the AF) and the second information is obtained through local configuration or reception.

The supporting PDU Set based handling includes supporting PDU Set based handling in at least one of uplink and downlink.

The not supporting PDU Set based handling includes not supporting PDU Set based handling in at least one of uplink and downlink.

In an implementation, PDU Set based handling being supported in uplink is determined based on at least one of the following:
PDU Set based handling is supported for the terminal, or uplink PDU Set based handling is supported for the terminal;
PDU Set based handling is supported or uplink PDU Set based handling is supported for the second communication device; and
the fifth information sent by the second communication device indicates that the uplink PDU Set based handling is supported.

In some implementations, the third operation includes:
in a case that an eleventh condition is met, performing, by the third communication device, at least one of the following:
rejecting the first request;
determining not to apply PDU Set based handling, and determining not to apply PDU Set based handling to uplink; and
sending at least one of PDU Set QoS, second information, third information, and a first response.

The meeting the eleventh condition includes at least one of the following:
PDU Set QoS is absent;
second information is absent, and the second information indicates one of the following: applying PDU Set importance, or applying PDU Set importance-based handling;
PDU Set based handling is not supported or uplink PDU Set based handling is not supported for the second communication device;
PDU Set based handling is not supported for the terminal, or uplink PDU Set based handling is not supported for the terminal;
the fifth information indicates information that PDU Set based handling is not supported in uplink; and
it is determined that PDU Set based handling is not supported, or it is determined that PDU Set based handling is not supported in uplink.

The second information indicates at least one of the following: applying PDU Set importance, or applying PDU Set importance-based handling;
the third information indicates one of the following: not applying PDU Set based handling, or not applying PDU Set based handling to uplink; and
the first response includes information for rejecting a first request.

In an implementation, at least one of PDU Set QoS (sent by the AF) and the second information is obtained through local configuration or reception.

The not supporting PDU Set based handling includes not supporting PDU Set based handling in at least one of uplink and downlink.

In an implementation, PDU Set based handling being not supported in uplink is determined based on at least one of the following:
PDU Set based handling is not supported for the terminal, or uplink PDU Set based handling is not supported for the terminal;
PDU Set based handling is not supported or uplink PDU Set based handling is not supported for the second communication device; and
the fifth information sent by the second communication device indicates that the uplink PDU Set based handling is not supported.

In some implementations, the not supporting PDU Set based handling includes that PDU Set based handling is not supported for the third object.

In some implementations, the not supporting uplink PDU Set based handling includes that PDU Set based handling is not supported in uplink of the third object.

The third object includes at least one of the following: such as the first QoS flow and a first rule (such as a PCC rule).

In some implementations, the third operation includes:
in a case that a twelfth condition is met, performing, by the third communication device, at least one of the following:
determining that PDU Set based handling is supported, or determining that PDU Set based handling is supported in uplink; and
sending at least one of the following: PDU Set QoS, second information, and fourth information.

The meeting the twelfth condition includes at least one of the following:
PDU Set QoS has been obtained or determined;
second information has been obtained or determined, and the second information indicates one of the following: applying PDU Set importance, or applying PDU Set importance-based handling;
PDU Set based handling is supported or uplink PDU Set based handling is supported for the second communication device;
PDU Set based handling is supported or uplink PDU Set based handling is supported for the terminal;
PDU Set based handling is supported or downlink PDU Set based handling is supported for an anchor gateway; and
the fifth information indicates information that PDU Set based handling is supported in uplink.

The second information indicates at least one of the following: applying PDU Set importance, or applying PDU Set importance-based handling.

The fourth information indicates one of the following: supporting PDU Set based handling, or supporting PDU Set based handling in uplink.

In an implementation, at least one of PDU Set QoS (sent by the AF) and the second information is obtained through local configuration or reception.

In an implementation, the supporting PDU Set based handling includes supporting PDU Set based handling in at least one of uplink and downlink.

In some implementations, the third operation includes:
in a case that a thirteenth condition is met, performing, by the third communication device, at least one of the following:
determining that PDU Set based handling is not supported, or determining that PDU Set based handling is not supported in uplink; and
sending at least one of the following: PDU Set QoS, second information, and fourth information.

The meeting the thirteenth condition includes at least one of the following:
PDU Set QoS has been obtained or determined;
second information has been obtained or determined, and the second information indicates one of the following: applying PDU Set importance, or applying PDU Set importance-based handling;
PDU Set based handling is not supported or uplink PDU Set based handling is not supported for the second communication device;
PDU Set based handling is not supported or uplink PDU Set based handling is not supported for the terminal;
PDU Set based handling is supported or downlink PDU Set based handling is supported for an anchor gateway; and
the fifth information indicates information that PDU Set based handling is not supported in uplink.

The second information indicates at least one of the following: applying PDU Set importance, or applying PDU Set importance-based handling; and the fourth information indicates one of the following: not supporting PDU Set based handling, or not supporting PDU Set based handling in uplink.

In some implementations, the third operation includes:
in a case that a fourteenth condition is met, performing, by the third communication device, at least one of the following:
accepting the first request;
determining to apply PDU Set based handling to downlink;
determining that PDU Set based handling is supported in downlink; and
sending at least one of PDU Set QoS, second information, third information, fourth information, and a first response.

The meeting the fourteenth condition includes at least one of the following:
PDU Set QoS has been obtained or determined;
protocol information used for PDU Set marking has been obtained or determined;
second information has been obtained or determined, and the second information indicates one of the following: applying PDU Set importance, or applying PDU Set importance-based handling;
PDU Set based handling is supported or downlink PDU Set based handling is supported for the second communication device; and
PDU Set based handling is supported or downlink PDU Set based handling is supported for an anchor gateway.

The first request includes information for requesting PDU Set based handling for downlink.

The second information indicates at least one of the following: applying PDU Set importance, or applying PDU Set importance-based handling.

The third information indicates applying PDU Set based handling to downlink.

The fourth information indicates that PDU Set based handling is supported in downlink.

In an implementation, at least one of PDU Set QoS (sent by the AF), protocol information used for PDU Set marking, and the second information is obtained through local configuration or reception.

In an implementation, the anchor gateway is, for example, a UPF that terminates an N6 interface.

In some implementations, the third operation includes:
in a case that a fifteenth condition is met, performing, by the third communication device, at least one of the following:
accepting the first request;
determining to apply PDU Set based handling to uplink;
determining that PDU Set based handling is supported in uplink; and
sending at least one of PDU Set QoS, second information, third information, fourth information, and a first response.

The meeting the fifteenth condition includes at least one of the following:
PDU Set QoS has been obtained or determined;
second information has been obtained or determined, and the second information indicates at least one of the following: applying PDU Set importance, or applying PDU Set importance-based handling;
the first request has been obtained;
PDU Set based handling is supported or uplink PDU Set based handling is supported for a RAN;
PDU Set based handling is supported or uplink PDU Set based handling is supported for the terminal; and
the fifth information indicates information that PDU Set based handling is supported in uplink.

The second information indicates at least one of the following: applying PDU Set importance, or applying PDU Set importance-based handling.

The third information indicates applying PDU Set based handling to uplink.

The fourth information indicates that PDU Set based handling is supported in uplink.

The first response includes information for accepting a first request.

In an implementation, at least one of PDU Set QoS (sent by the AF) and the second information is obtained through local configuration or reception.

In an implementation, the first request includes information for requesting PDU Set based handling for uplink.

In some implementations, the third operation includes:
in a case that a sixteenth condition is met, performing, by the third communication device, at least one of the following:
rejecting the first request;
determining not to apply PDU Set based handling to uplink;
determining that PDU Set based handling is not supported in uplink; and
sending at least one of third information, fourth information, and a first response.

The meeting the sixteenth condition includes at least one of the following:
PDU Set QoS is absent;
second information is absent, and the second information indicates at least one of the following: applying PDU Set importance, or applying PDU Set importance-based handling;
the fifth information indicates information that PDU Set based handling is not supported in uplink;
PDU Set based handling is not supported or uplink PDU Set based handling is not supported for the terminal;
PDU Set based handling is not supported or uplink PDU Set based handling is not supported for the second communication device;
the first request has been rejected or the second request has not been received; and
the fifth information indicates information that PDU Set based handling is not supported in uplink.

The third information indicates not applying PDU Set based handling to uplink.

The fourth information indicates that PDU Set based handling is not supported in uplink.

The first response includes information for rejecting a first request.

In some implementations, the sending the first request to the fourth communication device includes:
in a case that a seventeenth condition is met, sending, by the third communication device, a first request to the fourth communication device.

The meeting the seventeenth condition includes at least one of the following:
it is determined that PDU Set based handling is supported, or it is determined that PDU Set based handling is supported in uplink;
the first request has been obtained;
PDU Set based handling is supported for the terminal, or uplink PDU Set based handling is supported for the terminal;
PDU Set based handling is not applied to uplink of a third object, or PDU Set based handling is not applied to the third object;
it is unclear whether PDU Set based handling is supported for the third object, or it is unclear whether PDU Set based handling is supported in uplink of the third object, or PDU Set based handling is supported for the third object, or PDU Set based handling is supported in uplink of the third object; and
at least one of PDU Set QoS, second information, third information, fourth information, and a first response that are corresponding to the third object is absent; where
the third object includes at least one of the following: a first QoS flow and a first rule.

In an implementation, the first rule is a rule (such as a PCC rule) bound to the first QoS flow.

In an implementation, the first QoS flow is a QoS flow bound to the first rule.

In an implementation, the third communication device receives and obtains the fourth information from the fourth communication device, and based on the fourth information, determines that PDU Set based handling is supported, or determines that PDU Set based handling is supported in uplink. For example, the information is obtained before the first request is received. However, the third communication device sends the first request to the fourth communication device because “a PDU Set based handling related parameter (such as PDU Set QoS and second information) corresponding to the first object is absent”.

In a case that PDU Set QoS corresponding to the third object and the second information are absent, in an implementation, the third communication device sends a first request to the fourth communication device. In another implementation, the third communication device rejects the first request.

In some implementations, the third operation further includes:
after the first request is sent to the fourth communication device, receiving first information sent by the fourth communication device; and
based on at least one of the first information, the first capability information, and the second request, performing a first sub-operation of the third operation.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

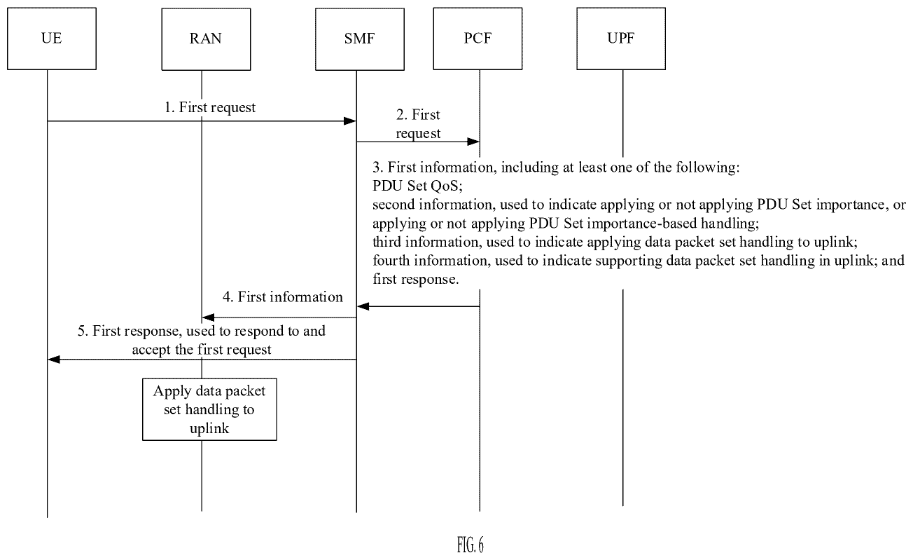

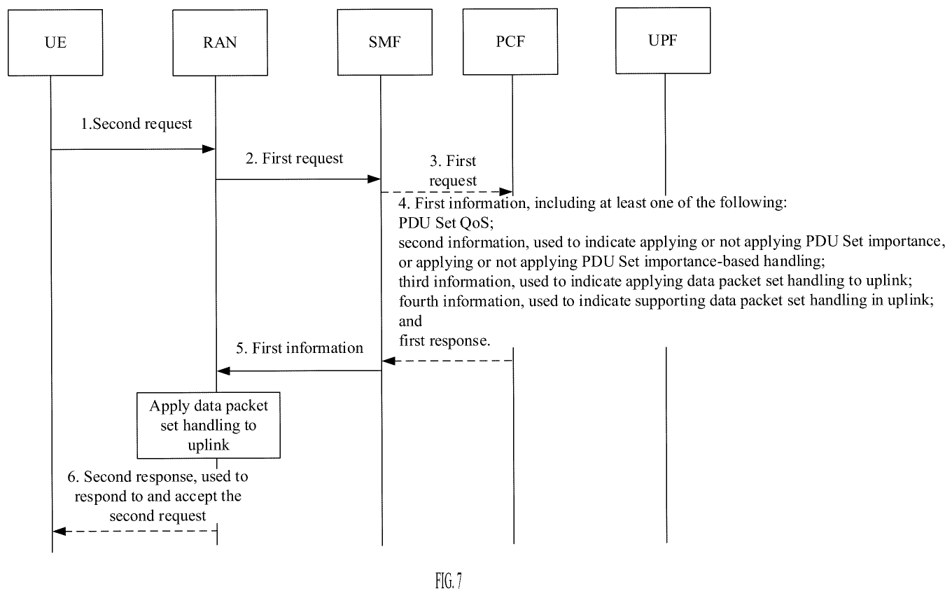

Referring to FIG. 5, an embodiment of this application provides an information processing method, applied to a fourth communication device. The fourth communication device includes but is not limited to a core network element (such as a PCF), and the method includes the following steps.

Step 51: The fourth communication device performs a fourth operation, where the fourth operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
performing a first sub-operation of the fourth operation based on at least one of the requested PDU Set QoS, the first request, the fifth information, and the first capability information.

The first sub-operation of the fourth operation includes at least one of the following:
accepting the first request or rejecting the first request; and
sending at least one of the following to a third communication device: the PDU Set QoS, the second information, the third information, the fourth information, and a first response.

The first request is used to request at least one of the following: PDU Set based handling, and a PDU Set parameter;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

In an implementation, the first request is a first request corresponding to a first rule (such as a PCC rule).

In some implementations, the fourth communication device locally configures or receives from at least one of the third communication device (such as an SMF) and a fifth communication device (such as an AF and a NEF) at least one of the following: PDU Set QoS, second information, third information, and fourth information.

In some implementations, at least one of the following is obtained from at least one of the third communication device (such as an SMF) and the fifth communication device (such as an AF and a NEF): requested PDU Set QoS, a first request, fifth information, and first capability information.

In some implementations, at least one of the following is sent to at least one of the third communication device (such as an SMF) and the fifth communication device (such as an AF and a NEF): PDU Set QoS, second information, third information, fourth information, and a first response.

In an implementation, in a case that requested PDU Set QoS is received (for example, received from the third communication device (such as an SMF)), PDU Set QoS is sent (for example, sent to the third communication device). It is easy to understand that the PDU Set QoS sent in this case is accepted PDU Set QoS.

The applying or not applying PDU Set based handling includes: applying or not applying PDU Set based handling to uplink and downlink.

In an implementation, the first information includes PDU Set QoS, second information, third information, fourth information, and a first response. The first information may be included in a first policy for sending.

The first information may be first information corresponding to the first policy (such as a PCC rule).

In an implementation, the third information may be used to indicate: applying PDU Set based handling to downlink, and not applying PDU Set based handling to uplink.

In another implementation, the third information may be used to indicate: applying PDU Set based handling to uplink, and not applying PDU Set based handling to downlink.

In another implementation, the third information may be used to indicate: applying PDU Set based handling to uplink and downlink.

In an implementation, the fourth communication device determines at least one of PDU Set QoS, second information, third information, and fourth information according to at least one of a request of the AF and a local configuration.

In another implementation, the fourth communication device determines at least one of PDU Set QoS, second information, third information, fourth information, and a first response according to at least one of a request of the AF, a local configuration, and the first request.

In some implementations, the PDU Set based handling includes at least one of the following:
handling a data packet based on a PDU Set granularity;
applying PDU Set QoS;
PDU Set QoS-based handling;
applying PDU Set importance; and
PDU Set importance-based handling.

In some implementations, the fourth operation includes: in a case that a tenth condition is met, performing, by the fourth communication device, at least one of the following:
accepting the first request;
determining to apply PDU Set based handling, or determining to apply PDU Set based handling to uplink; and
sending at least one of PDU Set QoS, second information, third information, and a first response.

The meeting the tenth condition is as described in the embodiment of the third communication device, and details are not repeated here.

The sent information is also as described in the embodiment of the third communication device, and details are not repeated here.

In some implementations, the fourth operation includes: in a case that an eleventh condition is met, performing, by the fourth communication device, at least one of the following:
rejecting the first request;
determining not to apply PDU Set based handling, and determining not to apply PDU Set based handling to uplink; and
sending at least one of PDU Set QoS, second information, third information, and a first response.

The meeting the eleventh condition is as described in the embodiment of the third communication device, and details are not repeated here.

The sent information is also as described in the embodiment of the third communication device, and details are not repeated here.

In some implementations, the fourth operation includes: in a case that a twelfth condition is met, performing, by the fourth communication device, at least one of the following:
determining that PDU Set based handling is supported, or determining that PDU Set based handling is supported in uplink; and
sending at least one of the following: PDU Set QoS, second information, and fourth information.

The meeting the twelfth condition is as described in the embodiment of the third communication device, and details are not repeated here.

The sent information is also as described in the embodiment of the third communication device, and details are not repeated here.

In some implementations, the fourth operation includes: in a case that a thirteenth condition is met, performing, by the fourth communication device, at least one of the following:
determining that PDU Set based handling is not supported, or determining that PDU Set based handling is not supported in uplink; and
sending at least one of the following: PDU Set QoS, second information, and fourth information.

The meeting the thirteenth condition is as described in the embodiment of the third communication device, and details are not repeated here.

The sent information is also as described in the embodiment of the third communication device, and details are not repeated here.

In some implementations, the fourth operation includes: in a case that a fourteenth condition is met, performing, by the fourth communication device, at least one of the following:
accepting the first request;
determining to apply PDU Set based handling to downlink;
determining that PDU Set based handling is supported in downlink; and
sending at least one of PDU Set QoS, second information, third information, fourth information, and a first response.

The meeting the fourteenth condition is as described in the embodiment of the third communication device, and details are not repeated here.

The sent information is also as described in the embodiment of the third communication device, and details are not repeated here.

In some implementations, the fourth operation includes: in a case that a fifteenth condition is met, performing, by the fourth communication device, at least one of the following:
accepting the first request;
determining to apply PDU Set based handling to uplink;
determining that PDU Set based handling is supported in uplink; and
sending at least one of PDU Set QoS, second information, third information, fourth information, and a first response.

The meeting the fifteenth condition is as described in the embodiment of the third communication device, and details are not repeated here.

The sent information is also as described in the embodiment of the third communication device, and details are not repeated here.

In some implementations, the fourth operation includes: in a case that a sixteenth condition is met, performing, by the fourth communication device, at least one of the following:
rejecting the first request;
determining not to apply PDU Set based handling to uplink;
determining that PDU Set based handling is not supported in uplink; and
sending at least one of third information, fourth information, and a first response.

The meeting the sixteenth condition is as described in the embodiment of the third communication device, and details are not repeated here.

The sent information is also as described in the embodiment of the third communication device, and details are not repeated here.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

The following describes the information processing method in the embodiments of this application with reference to specific application scenarios.

### Embodiment 1 of this Application

As shown in FIG. 6, embodiment 1 of this application includes the following steps:

Step 1: UE sends a first request to an SMF through an AMF (not shown in the figure). In some implementations, the first request may be a first request corresponding to a first QoS flow.

In some implementations, the first request may be included and sent in a NAS message (such as a PDU session modification request).

The first request is used for requesting PDU Set based handling (including requesting PDU Set based handling for at least one of uplink and downlink).

The first request corresponding to the first QoS flow is used for requesting PDU Set based handling for the first QoS flow (including requesting PDU Set based handling for at least one of uplink and downlink of the first object).

The PDU Set based handling is as described in the embodiment of the first communication device, and details are not repeated here.

Step 2: The SMF performs a first sub-operation of a third operation or a second sub-operation of the third operation based on the first request.

The first sub-operation of the third operation includes at least one of the following:
accepting the first request or rejecting the first request;
determining at least one of the following: PDU Set QoS, second information, third information, fourth information, and a first response; and
sending at least one of the following to at least one of a first communication device and a second communication device: the PDU Set QoS, the second information, the third information, the fourth information, and the first response.

The second sub-operation of the third operation includes at least one of the following:
determining a first request corresponding to a first PCC rule based on the first request of the first QoS flow; and
sending at least one of requested PDU Set QoS, a first request, fifth information, and first capability information to a PCF.

The first PCC rule is a PCC rule flow bound to the first QoS flow.

In an embodiment shown in FIG. 6, the SMF performs the second sub-operation of the third operation and sends the first request to the PCF.

In an implementation, the PDU Set QoS is used to implicitly indicate: applying PDU Set QoS to downlink, and applying PDU Set QoS-based handling to downlink.

In an implementation, the applying PDU Set importance implicitly indicates: applying PDU Set importance to downlink.

In an implementation, the applying PDU Set importance-based handling implicitly indicates: applying PDU Set importance-based handling to downlink.

In this case, it is easy to understand that the third information may merely indicate applying PDU Set based handling to uplink.

In this case, it is easy to understand that the fourth information may merely indicate that PDU Set based handling is supported in uplink.

In an implementation, applying or not applying PDU Set importance includes applying or not applying PDU Set importance to at least one of uplink and downlink.

In an implementation, applying or not applying PDU Set importance-based handling includes applying or not applying PDU Set importance-based handling to at least one of uplink and downlink.

Step 3: The PCF performs a first sub-operation of a fourth operation based on the first request.

The first sub-operation of the fourth operation includes at least one of the following:
accepting the first request or rejecting the first request; and
sending first information to the SMF, where the first information includes at least one of the following: PDU Set QoS, second information, third information, fourth information, and a first response.

The second information is used to indicate: applying or not applying PDU Set importance, or applying or not applying PDU Set importance-based handling.

The third information is used to indicate: applying PDU Set based handling to uplink (in a case that PDU Set QoS and the third information are present, indication for downlink is defaulted).

The fourth information is used for indicating that PDU Set based handling is supported in uplink.

The first response includes information for accepting or rejecting a first request.

Step 4: The SMF sends first information to a RAN through the AMF, where the first information includes at least one of the following: PDU Set QoS, second information, third information, fourth information, and a first response.

Step 5: The SMF sends a first response to UE through the AMF, where the first response includes information for accepting the first request.

In this embodiment, the sending order in steps 4 and 5 is not a sequential order.

The first information and the first response may be included and sent in a same NG interface message.

### Embodiment 2 of this Application

As shown in FIG. 7, embodiment 2 of this application includes the following steps:

Step 1: UE sends a second request to a RAN. In some implementations, the second request may be a second request corresponding to a first radio bearer (such as a Data Radio Bearer (DRB) or a logical channel).

In some implementations, the second request may be included in a Radio Resource Control (RRC) message and sent to the RAN.

The second request is used to request PDU Set based handling (including requesting PDU Set based handling for at least one of uplink and downlink).

A second request corresponding to a first object is used for performing PDU Set based handling on the first object (including requesting PDU Set based handling on at least one of uplink and downlink of the first object).

The PDU Set based handling is as described in the embodiment of the first communication device, and details are not repeated here.

Step 2: Based on the second request, the RAN sends a first request to a CN (for example, to an SMF through an AMF). In some implementations, the first request may be a first request corresponding to a first QoS flow. The first QoS flow is a QoS flow mapped to the first radio bearer.

In some implementations, the first request may be included in a PDU session container in an NG message (such as a PDU session modification request) and sent to the SMF.

In some implementations, in a case that a third condition is met, the RAN sends the first request to the CN.

The third condition is as described in the embodiment of the second communication device, and details are not repeated here.

In some implementations, the first request sent by the RAN to the CN may be the first request corresponding to the first QoS flow. The first request corresponding to the first QoS flow is used for requesting PDU Set based handling for the first QoS flow (including requesting PDU Set based handling for at least one of uplink and downlink of the first QoS flow).

In some implementations, in a case that a fourth condition is met, the RAN accepts the first request of the UE.

The fourth condition is as described in the embodiment of the second communication device, and details are not repeated here.

In some implementations, in a case that a fifth condition is met, the RAN accepts the first request of the UE.

The fifth condition is as described in the embodiment of the second communication device, and details are not repeated here.

Step 3 to step 5 are the same as step 2 to step 4 in embodiment 1, and details are not repeated here.

Step 6: The RAN sends a second response to the UE, where the second response includes information for accepting the second request.

### Embodiment 3 of this Application

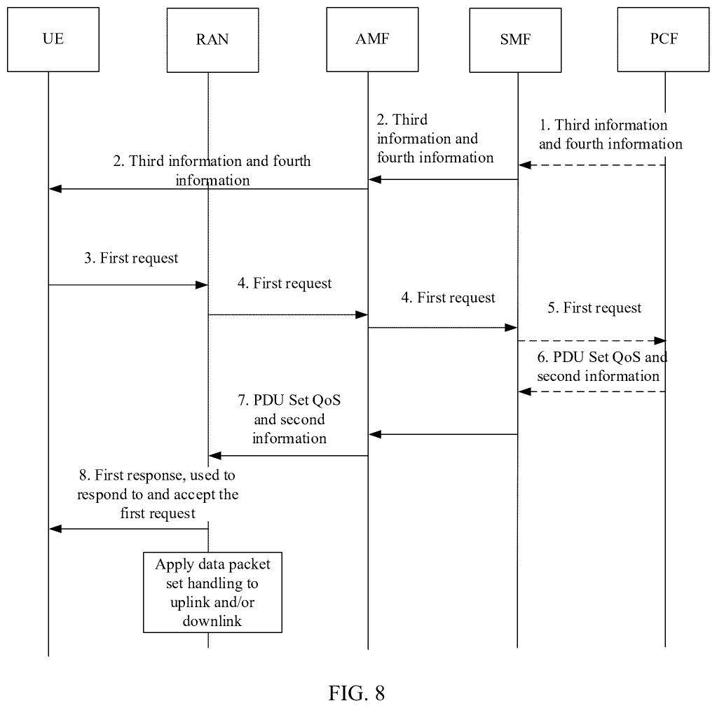

As shown in FIG. 8, embodiment 3 of this application includes the following steps.

Step 1: In some implementations, a PCF sends at least one of the following to an SMF: third information and fourth information. The sent information may be information corresponding to a first policy.

For example, the third information is used for indicating at least one of the following: applying PDU Set based handling, or applying PDU Set based handling to uplink.

For example, the fourth information is used for indicating at least one of the following: supporting PDU Set based handling, or supporting PDU Set based handling in uplink.

Step 2: The SMF sends first information to an AMF, where the first information includes at least one of the following: PDU Set QoS, second information, third information, and fourth information. For example, the first information includes the fourth information (such as PDU Set based handling is possible).

At least one of the third information and the fourth information may be included in a PDU session related container.

The first information and the information for indicating that PDU Set based handling is supported can be sent to the AMF in a same message.

In some implementations, the AMF sends at least one of the third information and the fourth information to UE.

Step 3: In some implementations, the UE sends a first request to a RAN based on at least one of the third information and the fourth information, in a case that a first condition is met.

For example, the first condition includes at least one of the following:
fourth information has been obtained, and the fourth information indicates at least one of the following: supporting PDU Set based handling, or indicating supporting PDU Set based handling in uplink; and
third information has been obtained, and the third information indicates at least one of the following: applying PDU Set based handling, and applying PDU Set based handling to uplink.

For step 4 to step 8, reference may be made to step 2 to step 6 of Embodiment 2, and details are not repeated here.

### Embodiment 4 of this Application

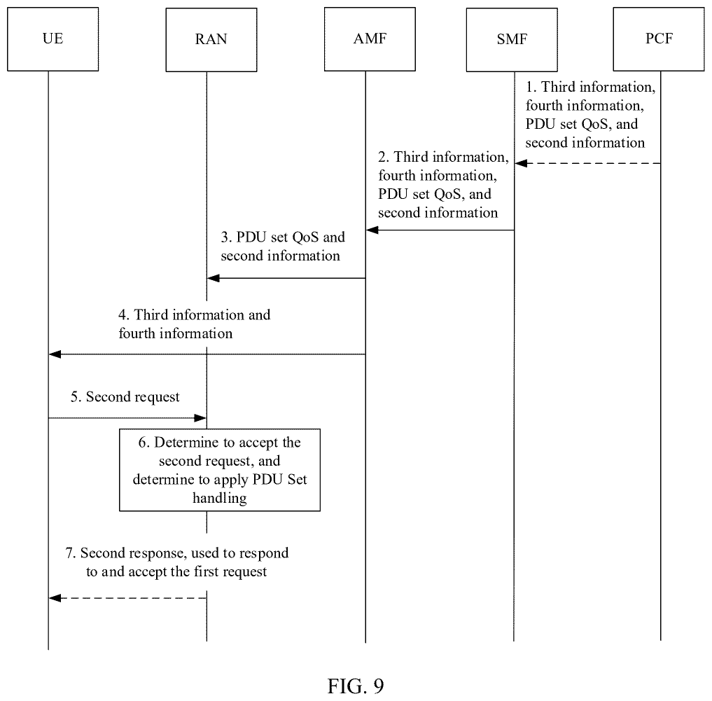

As shown in FIG. 9, embodiment 4 of this application includes the following steps.

Step 1: In some implementations, a PCF sends at least one of the following to an SMF: PDU Set QoS, second information, third information, and fourth information. The sent information may be information corresponding to a first policy.

For example, the third information is used for indicating at least one of the following: applying PDU Set based handling, or applying PDU Set based handling to uplink.

For example, the fourth information is used for indicating at least one of the following: supporting PDU Set based handling, or supporting PDU Set based handling in uplink.

Step 2: The SMF sends first information to an AMF, where the first information includes at least one of the following: PDU Set QoS, second information, third information, and fourth information. For example, the first information includes the fourth information (such as PDU Set based handling is possible).

At least one of the third information and the fourth information may be included in a PDU session related container.

Step 3: The AMF sends at least one of PDU Set QoS and the second information to a RAN.

The first information and the information for indicating that PDU Set based handling is supported can be sent to the AMF in a same message.

Step 4: In some implementations, the AMF sends at least one of the third information and the fourth information to UE.

Step 5: In some implementations, the UE sends a second request to the RAN based on at least one of the third information and the fourth information, in a case that a first condition is met.

For example, the first condition includes at least one of the following:
fourth information has been obtained, and the fourth information indicates at least one of the following: supporting PDU Set based handling, or indicating supporting PDU Set based handling in uplink; and
third information has been obtained, and the third information indicates at least one of the following: applying PDU Set based handling, and applying PDU Set based handling to uplink.

Step 6 and step 7: In some implementations, based on at least one of PDU Set QoS and the second information, the RAN performs a first sub-operation of a second operation, including at least one of the following:
accepting the second request or rejecting the second request;
determining to apply or not to apply PDU Set based handling, or determining to apply or not to apply PDU Set based handling to uplink; and
sending a second response to the UE.

### Embodiment 5 of this Application

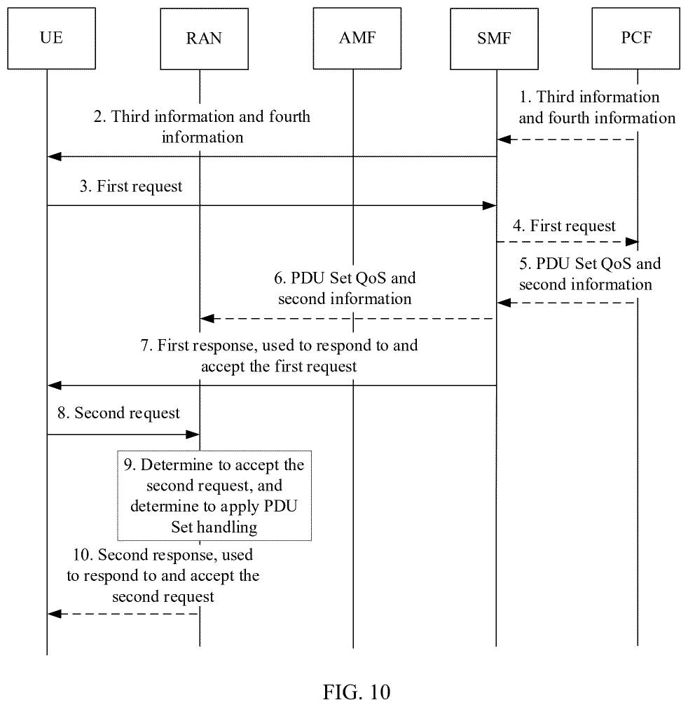

As shown in FIG. 10, embodiment 5 of this application includes the following steps.

Step 1: In some implementations, a PCF sends at least one of the following to an SMF: PDU Set QoS, second information, third information, and fourth information. The sent information may be information corresponding to a first policy.

For example, the third information is used for indicating at least one of the following: applying PDU Set based handling, or applying PDU Set based handling to uplink.

For example, the fourth information is used for indicating at least one of the following: supporting PDU Set based handling, or supporting PDU Set based handling in uplink.

Step 2: In some implementations, the SMF sends at least one of the third information and the fourth information to UE.

Step 3: In some implementations, the UE sends a first request to the SMF based on at least one of the third information and the fourth information, in a case that a first condition is met.

For example, the first condition includes at least one of the following:
fourth information has been obtained, and the fourth information indicates at least one of the following: supporting PDU Set based handling, or indicating supporting PDU Set based handling in uplink; and
third information has been obtained, and the third information indicates at least one of the following: applying PDU Set based handling, and applying PDU Set based handling to uplink.

Step 4 to step 7 are the same as step 2 to step 5 in embodiment 1, and details are not repeated here.

Step 8: In some implementations, the UE sends a second request to a RAN based on a first response in a case that a second condition is met.

For example, the second condition includes at least one of the following:
a first response has been obtained, and the first response includes information for accepting a first request;
fourth information has been obtained, and the fourth information indicates at least one of the following: supporting PDU Set based handling, or indicating supporting PDU Set based handling in uplink;
PDU Set QoS has been obtained;
second information has been obtained; and
third information has been obtained, and the third information indicates at least one of the following: applying PDU Set based handling, and applying PDU Set based handling to uplink.

Step 9 and step 10: In some implementations, based on at least one of PDU Set QoS and the second information, the RAN performs a second sub-operation of a second operation, including at least one of the following:
accepting the second request or rejecting the second request;
determining to apply or not to apply PDU Set based handling, or determining to apply or not to apply PDU Set based handling to uplink; and
sending a second response to the UE.

In the information processing method provided in this embodiment of this application, the executing subject can be an information processing apparatus. In the embodiments of this application, the information processing apparatus provided in the embodiments of this application is described by using PDU Set based handling being executed by the information processing apparatus as an example.

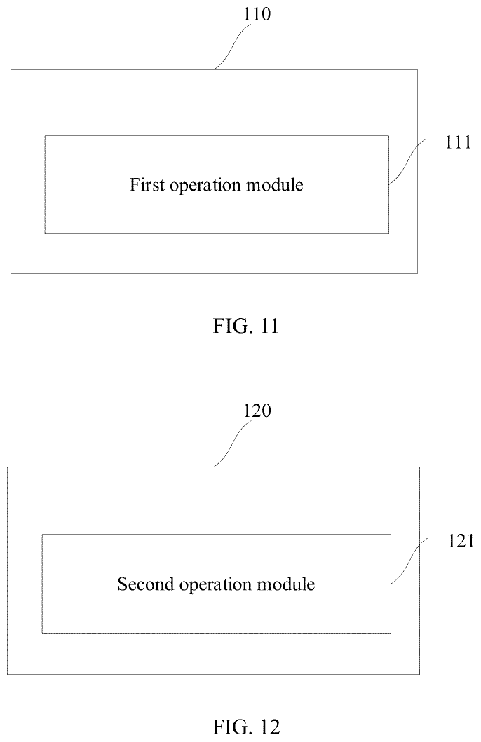

Refer to FIG. 11. An embodiment of this application further provides an information processing apparatus 110, including:
a first operation module 111, configured to perform a first operation, where the first operation includes at least one of the following:
sending at least one of the following to a second communication device: a second request and first capability information; and
sending at least one of the following to a core network element: a first request, the first capability information, and requested PDU Set QoS;
where
the first request or the second request is used to request PDU Set based handling; and
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal.

In some implementations, the PDU Set based handling includes at least one of the following:
handling a data packet based on a PDU Set granularity;
applying PDU Set QoS;
PDU Set QoS-based handling;
applying PDU Set importance; and
PDU Set importance-based handling.

In some implementations, the first operation further includes:
receiving fourth information, and determining, based on the fourth information, whether to send or not to send at least one of the following: the first request, the requested PDU Set QoS, and the second request;
or
after the step of sending the first request, receiving at least one of a first response, PDU Set QoS, second information, third information, and fourth information, and determining, based on at least one of the first response, the PDU Set QoS, the second information, the third information, and the fourth information, whether to send or not to send the second request.

The second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink; and
the first response includes information for accepting or rejecting a first request.

In some implementations, the first operation further includes:
after the step of sending the second request, receiving at least one of the following: third information, fourth information, and a second response.

In some implementations, the sending at least one of the following to a core network element: a first request, first capability information, and requested PDU Set QoS includes:
in a case that a first condition is met, sending at least one of the following: the first request, the first capability information, and the requested PDU Set QoS.

The meeting the first condition includes at least one of the following:
a requirement for applying PDU Set based handling has been generated or obtained;
it is determined that PDU Set based handling is supported, or it is determined that PDU Set based handling is supported in uplink;
fourth information has been obtained, and the fourth information indicates at least one of the following: supporting PDU Set based handling, or indicating supporting PDU Set based handling in uplink; and
PDU Set based handling is supported for the terminal, or uplink PDU Set based handling is supported for the terminal.

In some implementations, the sending the second request to the second communication device includes:
in a case that a second condition is met, sending the second request to the second communication device.

The meeting the second condition includes at least one of the following:
a requirement for applying PDU Set based handling has been generated or obtained;
a first response has been obtained, and the first response includes information for accepting a first request;
fourth information has been obtained, and the fourth information indicates at least one of the following: supporting PDU Set based handling, or indicating supporting PDU Set based handling in uplink;
PDU Set QoS has been obtained;
second information has been obtained; and
third information has been obtained, and the third information indicates at least one of the following: applying PDU Set based handling, and applying PDU Set based handling to uplink.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

The information processing apparatus in this embodiment of this application may be an electronic device, such as an electronic device with an operating system, or a component in the electronic device, such as an integrated circuit or a chip. The electronic device may be a terminal or a device other than terminals. For example, the terminal may include, but is not limited to, the types of the terminal 11 listed above, and other devices may be a server, a Network Attached Storage (NAS), and the like. This is not limited in the embodiments of this application.

The information processing apparatus provided in this embodiment of this application can implement the processes implemented in the method embodiments in FIG. 2, with the same technical effects achieved. To avoid repetition, details are not described herein again.

Refer to FIG. 12. An embodiment of this application further provides an information processing apparatus 120, including:
a second operation module 121, configured to perform a second operation, where the second operation includes at least one of the following:
determining to apply or not to apply PDU Set based handling, or determining to apply or not to apply PDU Set based handling to uplink;
determining that PDU Set based handling is supported or not supported, or determining that PDU Set based handling is supported or not supported to uplink;
receiving at least one of the following sent by a first communication device: a second request and first capability information;
sending at least one of the following to a core network element based on at least one of the second request and the first capability information: a first request, the first capability information, and fifth information, where the fifth information is used for indicating one of the following: information that PDU Set based handling is supported in uplink and information that PDU Set based handling is not supported in uplink;
receiving first information sent by the core network element; and
performing a first sub-operation of the second operation based on at least one of the first information, the first capability information, and the second request.

The first sub-operation of the second operation includes at least one of the following:
accepting the second request or rejecting the second request;
determining to apply or not to apply PDU Set based handling, or determining to apply or not to apply PDU Set based handling to uplink;
sending at least one of the following to the first communication device: third information, fourth information, and a second response; and
sending fifth information to a third communication device;
where
the first request or the second request is used to request PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the first information includes at least one of the following: PDU Set QoS, second information, the third information, the fourth information, and a first response;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the first response includes information for accepting or rejecting a first request; and
the second response includes information for accepting or rejecting a second request.

In some implementations, the sending the first request to the core network element based on at least one of the second request and the first capability information includes:
in a case that a third condition is met, sending, by the second communication device, the first request to the core network element.

The meeting the third condition includes at least one of the following:
it is determined that PDU Set based handling is supported, or it is determined that PDU Set based handling is supported in uplink;
the second request has been obtained;
PDU Set based handling is supported for the terminal, or uplink PDU Set based handling is supported for the terminal;
PDU Set based handling is not applied to uplink of a first object, or PDU Set based handling is not applied to the first object;
it is unclear whether PDU Set based handling is supported for the first object, or it is unclear whether PDU Set based handling is supported in uplink of the first object, or PDU Set based handling is supported for the first object, or PDU Set based handling is supported in uplink of the first object;
at least one of the following corresponding to the first object is absent: PDU Set QoS, second information, third information, fourth information, and a first response; and
the first object includes at least one of the following: a first radio bearer and a first QoS flow.

In some implementations, the second operation includes:
after the step of sending the first request to the core network element, receiving first information sent by the core network element; and
performing a first sub-operation of the second operation based on at least one of the first information, the first capability information, and the second request.

In some implementations, the first sub-operation of the second operation includes:
in a case that a fourth condition is met, performing, by the second communication device, at least one of the following:
accepting the second request;
sending at least one of third information, fourth information, and a second response to the first communication device; and
sending, to the third communication device, fifth information indicating that PDU Set based handling is supported in uplink.

The fourth information indicates at least one of the following: supporting PDU Set based handling, or supporting PDU Set based handling in uplink.

The third information indicates at least one of the following: applying PDU Set based handling, or applying PDU Set based handling to uplink.

The second response includes information for accepting the second request.

The meeting the fourth condition includes at least one of the following:
it is determined to apply PDU Set based handling, or apply PDU Set based handling to uplink;
it is determined that PDU Set based handling is supported or PDU Set based handling is supported in uplink;
PDU Set QoS corresponding to a first object is present;
second information corresponding to the first object is present, and the second information indicates one of the following: applying PDU Set importance, or applying PDU Set importance-based handling;
third information corresponding to the first object is present, and the third information indicates one of the following: applying PDU Set based handling, or applying PDU Set based handling to uplink;
fourth information corresponding to the first object is present, and the fourth information indicates one of the following: supporting PDU Set based handling, or supporting PDU Set based handling in uplink;
a first response corresponding to the first object is present, and the first response includes information for accepting a first request; and
first capability information is present, and the first capability information indicates one of the following: PDU Set based handling is supported for the terminal, or uplink PDU Set based handling is supported for the terminal.

The first object includes at least one of the following: a first radio bearer and a first QoS flow.

In some implementations, the meeting the fourth condition includes:
based on at least one of the first capability information and the first information, it is determined that the fourth condition is met.

In some implementations, the first sub-operation of the second operation includes:
in a case that a fifth condition is met, performing, by the second communication device, at least one of the following:
rejecting the second request;
sending at least one of third information, fourth information, and a second response to the first communication device; and
sending, to the third communication device, fifth information indicating that PDU Set based handling is not supported in uplink.

The fourth information indicates at least one of the following: not supporting PDU Set based handling, or indicating not supporting PDU Set based handling in uplink.

The third information indicates at least one of the following: not applying PDU Set based handling, or not applying PDU Set based handling to uplink.

The second response includes information for rejecting the first request.

The meeting the fifth condition includes at least one of the following:
it is determined that PDU Set based handling is not supported or PDU Set based handling is not supported in uplink;
it is determined not to apply PDU Set based handling, or not to apply PDU Set based handling to uplink;
at least one of PDU Set QoS, second information, third information, and fourth information that are corresponding to the first object is absent;
second information corresponding to the first object is present, and the second information indicates one of the following: not applying PDU Set importance, or not applying PDU Set importance-based handling;
third information corresponding to the first object is present, and the third information indicates one of the following: not applying PDU Set based handling, or not applying PDU Set based handling to uplink;
fourth information corresponding to the first object is present, and the fourth information indicates one of the following: not supporting PDU Set based handling, or not supporting PDU Set based handling in uplink;
a first response corresponding to the first object is present, and the first response includes information for rejecting a first request; and
first capability information is present, and the first capability information indicates one of the following: PDU Set based handling is not supported for the terminal, or uplink PDU Set based handling is not supported for the terminal.

The first object includes at least one of the following: a first radio bearer and a first QoS flow.

In some implementations, the meeting the fifth condition includes: based on at least one of the first capability information and the first information, it is determined that the fifth condition is met.

In some implementations, the second operation includes:
in a case that a sixth condition is met, performing, by the second communication device, the following:
determining to apply PDU Set based handling, or determining to apply PDU Set based handling to uplink; and
sending third information to the first communication device.

The third information indicates at least one of the following: applying PDU Set based handling, or applying PDU Set based handling to uplink.

The meeting the sixth condition includes at least one of the following:
it is determined that PDU Set based handling is supported, or it is determined that PDU Set based handling is supported in uplink;
a second request has been received, and the second request is able to be accepted;
PDU Set QoS corresponding to a first object is present;
second information corresponding to the first object is present, and the second information indicates one of the following: applying PDU Set importance, or applying PDU Set importance-based handling;
third information corresponding to the first object is present, and the third information indicates one of the following: applying PDU Set based handling, or applying PDU Set based handling to uplink;
fourth information corresponding to the first object is present, and the fourth information indicates one of the following: supporting PDU Set based handling, or supporting PDU Set based handling in uplink;
a first response corresponding to the first object is present, and the first response includes information for accepting a first request; and
first capability information is present, and the first capability information indicates one of the following: PDU Set based handling is supported for the terminal, or uplink PDU Set based handling is supported for the terminal.

In some implementations, the second operation includes:
in a case that a seventh condition is met, performing, by the second communication device, at least one of the following:
determining not to apply PDU Set based handling, or not to apply PDU Set based handling to uplink; and
sending third information to the first communication device.

The third information indicates at least one of the following: not applying PDU Set based handling, or not applying PDU Set based handling to uplink.

The meeting the seventh condition includes at least one of the following:
it is determined that PDU Set based handling is not supported, or it is determined that PDU Set based handling is not supported in uplink;
a second request has been rejected, or a corresponding first request has been rejected, or a second request has not been received;
at least one of PDU Set QoS, second information, third information, and fourth information that are corresponding to the first object is absent;
second information corresponding to the first object is present, and the second information indicates one of the following: not applying PDU Set importance, or not applying PDU Set importance-based handling;
third information corresponding to the first object is present, and the third information indicates one of the following: not applying PDU Set based handling, or not applying PDU Set based handling to uplink;
fourth information corresponding to the first object is present, and the fourth information indicates one of the following: not supporting PDU Set based handling, or not supporting PDU Set based handling in uplink;
a first response corresponding to the first object is present, and the first response includes information for rejecting a first request; and
first capability information is present, and the first capability information indicates one of the following: PDU Set based handling is not supported for the terminal, or uplink PDU Set based handling is not supported for the terminal.

In some implementations, the second operation includes:
in a case that an eighth condition is met, performing, by the second communication device, at least one of the following:
determining that PDU Set based handling is not supported or PDU Set based handling is not supported in uplink;
sending fourth information to the first communication device; and
sending, to the third communication device, fifth information indicating that PDU Set based handling is not supported in uplink.

The fourth information indicates at least one of the following: supporting PDU Set based handling, or supporting PDU Set based handling in uplink.

The meeting the eighth condition includes at least one of the following:
it is determined not to apply PDU Set based handling, or it is determined not to apply uplink PDU Set based handling;
at least one of PDU Set QoS, second information, third information, and fourth information that are corresponding to the first object is absent;
second information corresponding to the first object is present, and the second information indicates one of the following: not applying PDU Set importance, or not applying PDU Set importance-based handling;
third information corresponding to the first object is present, and the third information indicates one of the following: not applying PDU Set based handling, or not applying PDU Set based handling to uplink;
fourth information corresponding to the first object is present, and the fourth information indicates one of the following: not supporting PDU Set based handling, or not supporting PDU Set based handling in uplink;
a first response corresponding to the first object is present, and the first response includes information for rejecting a first request; and
first capability information is present, and the first capability information indicates one of the following: PDU Set based handling is not supported for the terminal, or uplink PDU Set based handling is not supported for the terminal.

In some implementations, the second operation includes:
in a case that a ninth condition is met, performing, by the second communication device, the following:
determining that PDU Set based handling is supported, or determining that PDU Set based handling is supported in uplink;
sending fourth information to the first communication device; and
sending, to the third communication device, fifth information indicating that PDU Set based handling is supported in uplink;
where the fourth information indicates at least one of the following: supporting PDU Set based handling, or indicating supporting PDU Set based handling in uplink.

The meeting the ninth condition includes at least one of the following:
it is determined to apply PDU Set based handling, or it is determined to apply uplink PDU Set based handling;
PDU Set QoS corresponding to a first object is present;
second information corresponding to the first object is present, and the second information indicates one of the following: applying PDU Set importance, or applying PDU Set importance-based handling;
third information corresponding to the first object is present, and the third information indicates one of the following: applying PDU Set based handling, or applying PDU Set based handling to uplink;
fourth information corresponding to the first object is present, and the fourth information indicates one of the following: supporting PDU Set based handling, or supporting PDU Set based handling in uplink;
a first response corresponding to the first object is present, and the first response includes information for accepting a first request; and
first capability information is present, and the first capability information indicates one of the following: PDU Set based handling is supported for the terminal, or uplink PDU Set based handling is supported for the terminal.

In some implementations, the not applying PDU Set based handling to uplink includes at least one of the following:
not handling a data packet for uplink based on a data packet set granularity;
not applying PDU Set QoS to uplink;
not performing PDU Set QoS-based handling for uplink;
not applying PDU Set importance to uplink; and
not performing PDU Set importance-based handling for uplink.

The not applying PDU Set QoS to uplink includes at least one of the following: not applying PDU Set QoS, applying data packet-level QoS, not applying PSDB, not applying PSER, not applying PSIHI, and not applying PDU Set importance.

In some implementations, the not applying PSDB to uplink includes one of the following: not using PSDB to replace PDB for uplink, and using PDB for uplink; and the not applying PSER to uplink includes one of the following: not using PSER to replace PER for uplink, and using PER for uplink.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

The information processing apparatus provided in this embodiment of this application can implement the processes implemented in the method embodiments in FIG. 3, with the same technical effects achieved. To avoid repetition, details are not described herein again.

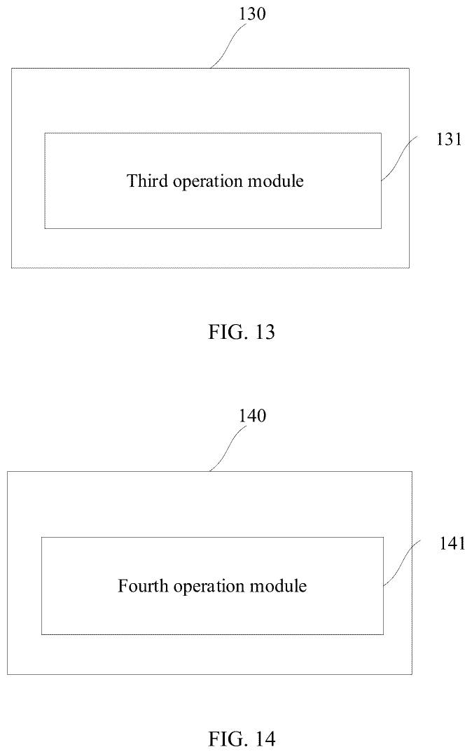

Refer to FIG. 13. An embodiment of this application further provides an information processing apparatus 130, including:
a third operation module 131, configured to perform a third operation, where the third operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
based on at least one of the requested PDU Set QoS, the first request, the fifth information, and the first capability information, performing a first sub-operation of the third operation, or performing a second sub-operation of the third operation;
the first sub-operation of the third operation includes at least one of the following:
accepting the first request or rejecting the first request;
determining at least one of the PDU Set QoS, the second information, the third information, the fourth information, and a first response; and
sending at least one of the following to at least one of a first communication device and a second communication device: the PDU Set QoS, the second information, the third information, the fourth information, and the first response.

The second sub-operation of the third operation includes at least one of the following:
determining, based on a first request of a first QoS flow, a first request corresponding to a first policy; and
sending at least one of the requested PDU Set QoS, a first request, fifth information, and first capability information to a fourth communication device.

The first request is used to request at least one of the following: PDU Set based handling;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

In some implementations, the information indicating that PDU Set based handling is supported is used as information for accepting the first request; and the information indicating that PDU Set based handling is not supported is used as information for rejecting the first request.

In some implementations, the third operation includes:
in a case that a tenth condition is met, performing, by the third communication device, at least one of the following:
accepting the first request;
determining to apply PDU Set based handling, or determining to apply PDU Set based handling to uplink; and
sending at least one of PDU Set QoS, second information, third information, and a first response.

The meeting the tenth condition includes at least one of the following:
PDU Set QoS has been obtained or determined;
second information has been obtained or determined, and the second information indicates one of the following: applying PDU Set importance, or applying PDU Set importance-based handling;
PDU Set based handling is supported or uplink PDU Set based handling is supported for the second communication device;
PDU Set based handling is supported or uplink PDU Set based handling is supported for the terminal;
PDU Set based handling is supported or downlink PDU Set based handling is supported for an anchor gateway;
the fifth information indicates information that PDU Set based handling is supported in uplink; and
it is determined that PDU Set based handling is supported or PDU Set based handling is supported in uplink.

The second information indicates at least one of the following: applying PDU Set importance, or applying PDU Set importance-based handling.

The third information indicates one of the following: applying PDU Set based handling, or applying PDU Set based handling to uplink.

The first response includes information for accepting a first request.

In some implementations, the third operation includes:
in a case that an eleventh condition is met, performing, by the third communication device, at least one of the following:
rejecting the first request;
determining not to apply PDU Set based handling, and determining not to apply PDU Set based handling to uplink; and
sending at least one of PDU Set QoS, second information, third information, and a first response.

The meeting the eleventh condition includes at least one of the following:
PDU Set QoS is absent;
second information is absent, and the second information indicates one of the following: applying PDU Set importance, or applying PDU Set importance-based handling;
PDU Set based handling is not supported or uplink PDU Set based handling is not supported for the second communication device;
PDU Set based handling is not supported for the terminal, or uplink PDU Set based handling is not supported for the terminal;
the fifth information indicates information that PDU Set based handling is not supported in uplink; and
it is determined that PDU Set based handling is not supported, or it is determined that PDU Set based handling is not supported in uplink.

The second information indicates at least one of the following: applying PDU Set importance, or applying PDU Set importance-based handling;
the third information indicates one of the following: not applying PDU Set based handling, or not applying PDU Set based handling to uplink; and
the first response includes information for rejecting a first request.

In some implementations, the third operation includes:
in a case that a twelfth condition is met, performing, by the third communication device, at least one of the following:
determining that PDU Set based handling is supported, or determining that PDU Set based handling is supported in uplink; and
sending at least one of the following: PDU Set QoS, second information, and fourth information.

The meeting the twelfth condition includes at least one of the following:
PDU Set QoS has been obtained or determined;
second information has been obtained or determined, and the second information indicates one of the following: applying PDU Set importance, or applying PDU Set importance-based handling;
PDU Set based handling is supported or uplink PDU Set based handling is supported for the second communication device;
PDU Set based handling is supported or uplink PDU Set based handling is supported for the terminal;
PDU Set based handling is supported or downlink PDU Set based handling is supported for an anchor gateway; and
the fifth information indicates information that PDU Set based handling is supported in uplink.

The second information indicates at least one of the following: applying PDU Set importance, or applying PDU Set importance-based handling.

The fourth information indicates one of the following: supporting PDU Set based handling, or supporting PDU Set based handling in uplink.

In some implementations, the third operation includes:
in a case that a thirteenth condition is met, performing, by the third communication device, at least one of the following:
determining that PDU Set based handling is not supported, or determining that PDU Set based handling is not supported in uplink; and
sending at least one of the following: PDU Set QoS, second information, and fourth information;
where
the meeting the thirteenth condition includes at least one of the following:
PDU Set QoS has been obtained or determined;
second information has been obtained or determined, and the second information indicates one of the following: applying PDU Set importance, or applying PDU Set importance-based handling;
PDU Set based handling is not supported or uplink PDU Set based handling is not supported for the second communication device;
PDU Set based handling is not supported or uplink PDU Set based handling is not supported for the terminal;
PDU Set based handling is supported or downlink PDU Set based handling is supported for an anchor gateway; and
the fifth information indicates information that PDU Set based handling is not supported in uplink.

The second information indicates at least one of the following: applying PDU Set importance, or applying PDU Set importance-based handling.

The fourth information indicates one of the following: not supporting PDU Set based handling, or not supporting PDU Set based handling in uplink.

In some implementations, the third operation includes:
in a case that a fourteenth condition is met, performing, by the third communication device, at least one of the following:
accepting the first request;
determining to apply PDU Set based handling to downlink;
determining that PDU Set based handling is supported in downlink; and
sending at least one of PDU Set QoS, second information, third information, fourth information, and a first response.

The meeting the fourteenth condition includes at least one of the following:
PDU Set QoS has been obtained or determined;
protocol information used for PDU Set marking has been obtained or determined;
second information has been obtained or determined, and the second information indicates one of the following: applying PDU Set importance, or applying PDU Set importance-based handling;
PDU Set based handling is supported or downlink PDU Set based handling is supported for the second communication device; and
PDU Set based handling is supported or downlink PDU Set based handling is supported for an anchor gateway.

The first request includes information for requesting PDU Set based handling for downlink;
the second information indicates at least one of the following: applying PDU Set importance, or applying PDU Set importance-based handling;
the third information indicates applying PDU Set based handling to downlink; and the fourth information indicates that PDU Set based handling is supported in downlink.

In some implementations, the third operation includes:
in a case that a fifteenth condition is met, performing, by the third communication device, at least one of the following:
accepting the first request;
determining to apply PDU Set based handling to uplink;
determining that PDU Set based handling is supported in uplink; and
sending at least one of PDU Set QoS, second information, third information, fourth information, and a first response.

The meeting the fifteenth condition includes at least one of the following:

PDU Set QoS has been obtained or determined;
second information has been obtained or determined, and the second information indicates at least one of the following: applying PDU Set importance, or applying PDU Set importance-based handling;
the first request has been obtained;
PDU Set based handling is supported or uplink PDU Set based handling is supported for a RAN;
PDU Set based handling is supported or uplink PDU Set based handling is supported for the terminal; and
the fifth information indicates information that PDU Set based handling is supported in uplink.

The second information indicates at least one of the following: applying PDU Set importance, or applying PDU Set importance-based handling.

The third information indicates applying PDU Set based handling to uplink.

The fourth information indicates that PDU Set based handling is supported in uplink.

The first response includes information for accepting a first request.

In some implementations, the third operation includes:
in a case that a sixteenth condition is met, performing, by the third communication device, at least one of the following:
rejecting the first request;
determining not to apply PDU Set based handling to uplink;
determining that PDU Set based handling is not supported in uplink; and
sending at least one of third information, fourth information, and a first response.

The meeting the sixteenth condition includes at least one of the following:
PDU Set QoS is absent;
second information is absent, and the second information indicates at least one of the following: applying PDU Set importance, or applying PDU Set importance-based handling;
the fifth information indicates information that PDU Set based handling is not supported in uplink;
PDU Set based handling is not supported or uplink PDU Set based handling is not supported for the terminal;
PDU Set based handling is not supported or uplink PDU Set based handling is not supported for the second communication device;
the first request has been rejected or the second request has not been received; and
the fifth information indicates information that PDU Set based handling is not supported in uplink.

The third information indicates not applying PDU Set based handling to uplink.

The fourth information indicates that PDU Set based handling is not supported in uplink.

The first response includes information for rejecting a first request.

In some implementations, the sending the first request to the fourth communication device includes:
in a case that a seventeenth condition is met, sending, by the third communication device, a first request to the fourth communication device.

The meeting the seventeenth condition includes at least one of the following:
it is determined that PDU Set based handling is supported, or it is determined that PDU Set based handling is supported in uplink;
the first request has been obtained;
PDU Set based handling is supported for the terminal, or uplink PDU Set based handling is supported for the terminal;
PDU Set based handling is not applied to uplink of a third object, or PDU Set based handling is not applied to the third object;
it is unclear whether PDU Set based handling is supported for the third object, or it is unclear whether PDU Set based handling is supported in uplink of the third object, or PDU Set based handling is supported for the third object, or PDU Set based handling is supported in uplink of the third object; and
at least one of PDU Set QoS, second information, third information, fourth information, and a first response that are corresponding to the third object is absent;
where
the third object includes at least one of the following: a first QoS flow and a first rule.

In some implementations, the third operation further includes:
after the first request is sent to the fourth communication device, receiving first information sent by the fourth communication device; and
based on at least one of the first information, the first capability information, and the second request, performing a first sub-operation of the third operation.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

The information processing apparatus provided in this embodiment of this application can implement the processes implemented in the method embodiments in FIG. 4, with the same technical effects achieved. To avoid repetition, details are not described herein again.

Refer to FIG. 14. An embodiment of this application further provides an information processing apparatus 140, including:
a fourth operation module 141, configured to perform a fourth operation, where the fourth operation includes at least one of the following:
determining at least one of the following: applying PDU Set based handling or not applying PDU Set based handling, applying or not applying PDU Set based handling to uplink, and applying or not applying PDU Set based handling to downlink;
determining at least one of the following: supporting PDU Set based handling or not supporting PDU Set based handling, supporting or not supporting PDU Set based handling in uplink, and supporting or not supporting PDU Set based handling in downlink;
obtaining or determining at least one of the following: PDU Set QoS, second information, third information, and fourth information;
sending at least one of the following: PDU Set QoS, second information, third information, and fourth information;
obtaining at least one of requested PDU Set QoS, a first request, fifth information, and first capability information; and
performing a first sub-operation of the fourth operation based on at least one of the requested PDU Set QoS, the first request, the fifth information, and the first capability information.

The first sub-operation of the fourth operation includes at least one of the following:
accepting the first request or rejecting the first request; and
sending at least one of the following to a third communication device: the PDU Set QoS, the second information, the third information, the fourth information, and a first response.

The first request is used to request at least one of the following: PDU Set based handling, and a PDU Set parameter;
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal;
the second information is used for indicating at least one of the following: applying or not applying PDU Set importance, and applying or not applying PDU Set importance-based handling;
the third information is used for indicating at least one of the following: applying or not applying PDU Set based handling, applying or not applying PDU Set based handling to uplink, and applying or not applying PDU Set based handling to downlink;
the fourth information is used for indicating at least one of the following: supporting or not supporting PDU Set based handling, supporting or not supporting PDU Set based handling in uplink, and supporting or not supporting PDU Set based handling in downlink;
the fifth information is used for indicating one of the following: information that PDU Set based handling is supported in uplink and information that PDU Set based handling is not supported in uplink; and
the first response includes information for accepting or rejecting a first request.

In some implementations, the PDU Set based handling includes at least one of the following:
handling a data packet based on a PDU Set granularity;
applying PDU Set QoS;
PDU Set QoS-based handling;
applying PDU Set importance; and
PDU Set importance-based handling.

In some implementations, the fourth operation includes: in a case that a tenth condition is met, performing, by the information processing apparatus, at least one of the following:
accepting the first request;
determining to apply PDU Set based handling, or determining to apply PDU Set based handling to uplink; and
sending at least one of PDU Set QoS, second information, third information, and a first response.

The meeting the tenth condition is as described in the embodiment of the third communication device, and details are not repeated here.

The sent information is also as described in the embodiment of the third communication device, and details are not repeated here.

In some implementations, the fourth operation includes: in a case that an eleventh condition is met, performing, by the information processing apparatus, at least one of the following:
rejecting the first request;
determining not to apply PDU Set based handling, and determining not to apply PDU Set based handling to uplink; and
sending at least one of PDU Set QoS, second information, third information, and a first response.

The meeting the eleventh condition is as described in the embodiment of the third communication device, and details are not repeated here.

The sent information is also as described in the embodiment of the third communication device, and details are not repeated here.

In some implementations, the fourth operation includes: in a case that a twelfth condition is met, performing, by the information processing apparatus, at least one of the following:
determining that PDU Set based handling is supported, or determining that PDU Set based handling is supported in uplink; and
sending at least one of the following: PDU Set QoS, second information, and fourth information.

The meeting the twelfth condition is as described in the embodiment of the third communication device, and details are not repeated here.

The sent information is also as described in the embodiment of the third communication device, and details are not repeated here.

In some implementations, the fourth operation includes: in a case that a thirteenth condition is met, performing, by the information processing apparatus, at least one of the following:
determining that PDU Set based handling is not supported, or determining that PDU Set based handling is not supported in uplink; and
sending at least one of the following: PDU Set QoS, second information, and fourth information.

The meeting the thirteenth condition is as described in the embodiment of the third communication device, and details are not repeated here.

The sent information is also as described in the embodiment of the third communication device, and details are not repeated here.

In some implementations, the fourth operation includes: in a case that a fourteenth condition is met, performing, by the information processing apparatus, at least one of the following:
accepting the first request;
determining to apply PDU Set based handling to downlink;
determining that PDU Set based handling is supported in downlink; and
sending at least one of PDU Set QoS, second information, third information, fourth information, and a first response.

The meeting the fourteenth condition is as described in the embodiment of the third communication device, and details are not repeated here.

The sent information is also as described in the embodiment of the third communication device, and details are not repeated here.

In some implementations, the fourth operation includes: in a case that a fifteenth condition is met, performing, by the information processing apparatus, at least one of the following:
accepting the first request;
determining to apply PDU Set based handling to uplink;
determining that PDU Set based handling is supported in uplink; and
sending at least one of PDU Set QoS, second information, third information, fourth information, and a first response.

The meeting the fifteenth condition is as described in the embodiment of the third communication device, and details are not repeated here.

The sent information is also as described in the embodiment of the third communication device, and details are not repeated here.

In some implementations, the fourth operation includes: in a case that a sixteenth condition is met, performing, by the information processing apparatus, at least one of the following:
rejecting the first request;
determining not to apply PDU Set based handling to uplink;
determining that PDU Set based handling is not supported in uplink; and
sending at least one of third information, fourth information, and a first response.

The meeting the sixteenth condition is as described in the embodiment of the third communication device, and details are not repeated here.

The sent information is also as described in the embodiment of the third communication device, and details are not repeated here.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

The information processing apparatus provided in this embodiment of this application can implement the processes implemented in the method embodiments in FIG. 5, with the same technical effects achieved. To avoid repetition, details are not described herein again.

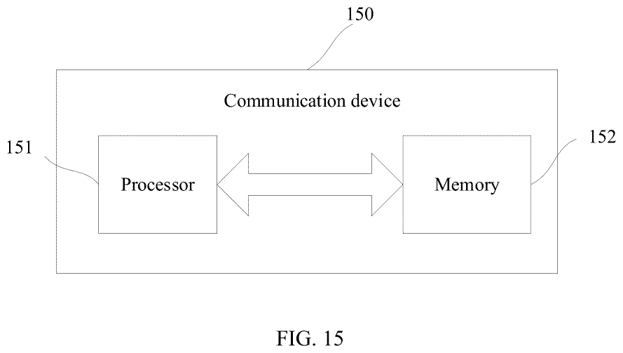

As shown in FIG. 15, an embodiment of this application further provides a communication device 150, including a processor 151 and a memory 152. A program or instructions capable of running on the processor 151 are stored in the memory 152. For example, when the communication device 150 is the first communication device and when the program or the instructions are executed by the processor 151, the steps of the foregoing embodiments of the information processing method executed by the first communication device are implemented, with the same technical effects achieved. When the communication device 150 is the second communication device and when the program or instruction is executed by the processor 151, the steps of the foregoing embodiments of the information processing method executed by the second communication device are implemented, with the same technical effects achieved. When the communication device 150 is the third communication device and when the program or instruction is executed by the processor 151, the steps of the foregoing embodiments of the information processing method executed by the third communication device are implemented, with the same technical effects achieved. When the communication device 150 is the fourth communication device and when the program or instruction is executed by the processor 151, the steps of the foregoing embodiments of the information processing method executed by the fourth communication device are implemented, with the same technical effects achieved. To avoid repetition, details are not repeated herein.

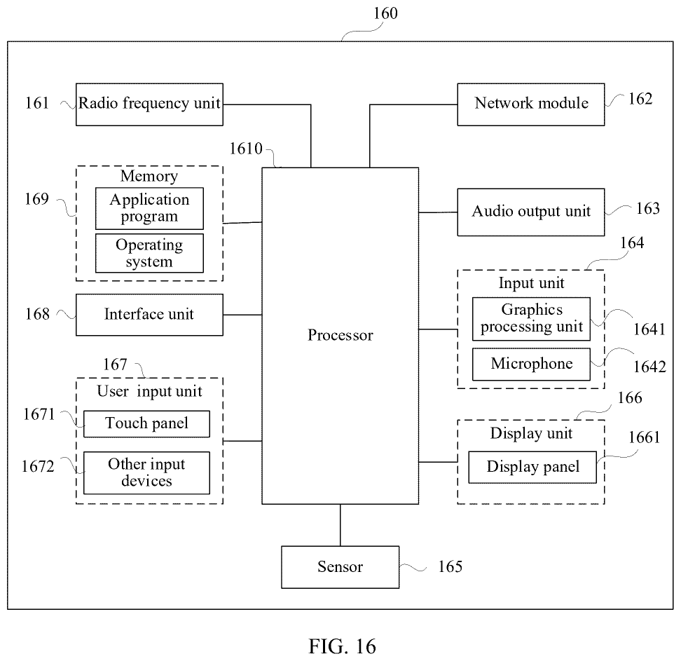

An embodiment of this application further provides a terminal, which includes a processor and a communication interface, where the communication interface is coupled to the processor, and the processor is configured to run a program or instructions to implement the steps of the method embodiments shown in FIG. 2. The terminal embodiment corresponds to the foregoing method embodiment of the first communication device side, and the implementation processes and implementations of the foregoing method embodiments can be applied to the terminal embodiments, with the same technical effects achieved. Specifically, FIG. 16 is a schematic diagram of a hardware structure of a terminal implementing an embodiment of this application.

The terminal 160 includes but is not limited to at least part of components such as a radio frequency unit 161, a network module 162, an audio output unit 163, an input unit 164, a sensor 165, a display unit 166, a user input unit 167, an interface unit 168, a memory 169, and a processor 1610.

Persons skilled in the art can understand that the terminal 160 may further include a power supply (for example, a battery) supplying power to the components, and the power supply may be logically connected to the processor 1610 through a power management system. In this way, functions such as charge management, discharge management, and power consumption management are implemented by using the power management system. The structure of the terminal shown in FIG. 16 does not constitute any limitation on the terminal. The terminal may include more or fewer components than shown in the figure, or a combination of some components, or the components disposed differently. Details are not described herein again.

It can be understood that in this embodiment of this application, the input unit 164 may include a Graphics Processing Unit (GPU) 1641 and a microphone 1642. The graphics processing unit 1641 processes image data of a still picture or video obtained by an image capture apparatus (such as a camera) in a video capture mode or an image capture mode. The display unit 166 may include a display panel 1661. The display panel 1661 may be configured in a form of a liquid crystal display, an organic light-emitting diode display, or the like. The user input unit 167 includes at least one of a touch panel 1671 and other input devices 1672. The touch panel 1671 is also referred to as a touchscreen. The touch panel 1671 may include two parts: a touch detection apparatus and a touch controller. The other input devices 1672 may include but be not limited to a physical keyboard, a function key (such as a volume control key or an on/off key), a trackball, a mouse, and a joystick. Details are not described herein.

In this embodiment of this application, after receiving downlink data from a network-side device, the radio frequency unit 161 sends the downlink data to the processor 1610 for processing; and the radio frequency unit 161 also sends uplink data to the network-side device. Generally, the radio frequency unit 161 includes but is not limited to an antenna, an amplifier, a transceiver, a coupler, a low noise amplifier, a duplexer, and the like.

The memory 169 may be configured to store software programs or instructions and various data. The memory 169 may mainly include a first storage area for storing programs or instructions and a second storage area for storing data, where the first storage area may store an operating system, an application program or instructions required by at least one function (for example, an audio playing function and an image playing function), and the like. Further, the memory 169 may include a volatile memory or a nonvolatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 169 described in the embodiments of this application is intended to include but is not limited to these and any other suitable types of memories.

The processor 1610 may include one or more processing units. In some implementations, the processor 1610 may integrate an application processor and a modem processor. The application processor primarily processes operations involving an operating system, user interface, application program, or the like. The modem processor primarily processes radio communication signals, for example, being a baseband processor. It should be understood that the modem processor may alternatively not be integrated into the processor 1610.

The processor 1610 is configured to perform a first operation; where the first operation includes at least one of the following:
sending at least one of the following to a second communication device: a second request and first capability information; and
sending at least one of the following to a core network element: a first request, the first capability information, and requested PDU Set QoS;
the first request or the second request is used to request PDU Set based handling; and
the first capability information is used for indicating one of the following: PDU Set based handling is supported for a terminal, PDU Set based handling is not supported for the terminal, uplink PDU Set based handling is supported for the terminal, and uplink PDU Set based handling is not supported for the terminal.

In this embodiment of this application, it is clear how the terminal, the RAN, and the core network cooperate to implement PDU Set based handling on demand, especially the uplink PDU Set based handling, and how the communication system as a whole performs PDU Set based handling, so that all communication devices in the communication system are clear about their respective PDU Set based handling methods and cooperate with each other to complete the PDU Set based handling, thereby resolving the PDU Set based handling problem and optimizing the communication process.

It can be understood that for the implementation processes of the implementations mentioned in this embodiment, reference may be made to the related descriptions of the method embodiments implemented by the first communication device, with the same or corresponding technical effects achieved. To avoid repetition, details are not described herein again.

An embodiment of this application further provides a network-side device, which includes a processor and a communication interface, where the communication interface is coupled to the processor, and the processor is configured to run a program or instructions to implement the steps of the method embodiments shown in FIG. 3. The network-side device embodiment corresponds to the foregoing method embodiment of the second communication device, and the implementation processes and implementations of the foregoing method embodiments can be applied to the network-side device embodiments, with the same technical effects achieved.

An embodiment of this application further provides a network-side device, which includes a processor and a communication interface, where the communication interface is coupled to the processor, and the processor is configured to run a program or instructions to implement the steps of the method embodiments shown in FIG. 4. The network-side device embodiment corresponds to the foregoing method embodiment of the third communication device, and the implementation processes and implementations of the foregoing method embodiments can be applied to the network-side device embodiments, with the same technical effects achieved.

An embodiment of this application further provides a network-side device, which includes a processor and a communication interface, where the communication interface is coupled to the processor, and the processor is configured to run a program or instructions to implement the steps of the method embodiments shown in FIG. 5. The network-side device embodiment corresponds to the foregoing method embodiment of the fourth communication device, and the implementation processes and implementations of the foregoing method embodiments can be applied to the network-side device embodiments, with the same technical effects achieved.

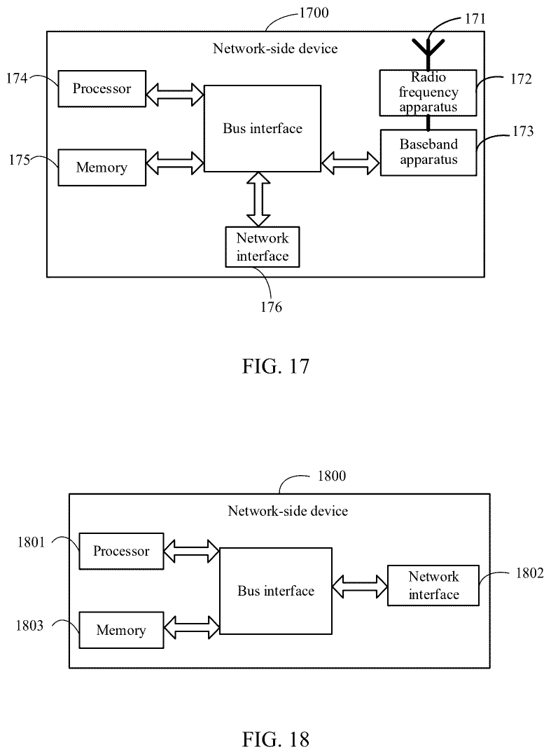

An embodiment of this application further provides a network-side device. As shown in FIG. 17, the network-side device 170 includes an antenna 171, a radio frequency apparatus 172, a baseband apparatus 173, a processor 174, and memory 175. The antenna 171 is connected to the radio frequency apparatus 172. In an uplink direction, the radio frequency apparatus 172 receives information by using the antenna 171, and sends the received information to the baseband apparatus 173 for processing. In a downlink direction, the baseband apparatus 173 processes to-be-sent information, and sends the information to the radio frequency apparatus 172; and the radio frequency apparatus 172 processes the received information and then sends the information out by using the antenna 171.

The method executed by the network-side device in the foregoing embodiments may be implemented on the baseband apparatus 173. The baseband apparatus 173 includes a baseband processor.

The baseband apparatus 173 may include, for example, at least one baseband board, where a plurality of chips are disposed on the baseband board. As shown in FIG. 17, one of the chips is, for example, the baseband processor, and connected to the memory 175 through a bus interface, to invoke the program in the memory 175 to perform the operations of the network device shown in the foregoing method embodiment.

The network-side device may further include a network interface 176, where the interface is, for example, a Common Public Radio Interface (CPRI).

In some implementations, the network-side device 170 according to this embodiment of this application further includes instructions or programs stored in the memory 175 and capable of running on the processor 174, and the processor 174 calls the instructions or programs in the memory 175 to execute the methods performed by the modules shown in FIG. 12, with the same technical effects achieved. To avoid repetition, details are not described herein again.

In some implementations, an embodiment of this application further provides a network-side device. As shown in FIG. 18, the network-side device 180 includes a processor 181, a network interface 182, and a memory 183. The network interface 182 is, for example, a CPRI.

In some implementations, the network-side device 180 in this embodiment of this application further includes: instructions or a program stored in the memory 183 and capable of running on the processor 181. The processor 181 invokes the instructions or program in the memory 183 to execute the method executed by the modules shown in FIG. 13 or FIG. 14, with the same technical effects achieved. To avoid repetition, details are not described herein again.

An embodiment of this application further provides a readable storage medium. The readable storage medium stores a program or instructions. When the program or instructions are executed by a processor, the processes of the foregoing embodiments of the information processing method are implemented, with the same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc. In some examples, the readable storage medium may be a non-transitory readable storage medium.

An embodiment of this application further provides a chip, where the chip includes a processor and a communication interface. The communication interface is coupled to the processor, and the processor is configured to run a program or instructions to implement the processes of the foregoing embodiments of the information processing method, with the same technical effects achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and when being executed by at least one processor, the computer program/program product is configured to implement the processes of the foregoing embodiments of the information processing method, with the same technical effects achieved. To avoid repetition, details are not repeated herein.

An embodiment of this application further provides a wireless communication system, which includes a first communication device, a second communication device, and a third communication device, where the first communication device can be configured to execute the steps of the foregoing method implemented by the first communication device, the second communication device can be configured to execute the steps of the foregoing method implemented by the second communication device, and the third communication device can be configured to execute the steps of the foregoing method implemented by the third communication device.

An embodiment of this application further provides a wireless communication system, including: a first communication device, a second communication device, a third communication device, and a fourth communication device, where the first communication device can be configured to execute the steps of the foregoing method implemented by the first communication device, the second communication device can be configured to execute the steps of the foregoing method implemented by the second communication device, the third communication device can be configured to execute the steps of the foregoing method implemented by the third communication device, and the fourth communication device can be configured to execute the steps of the foregoing method implemented by the fourth communication device.

It should be noted that in this specification, the terms “include” and “comprise,” or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples can be combined in other examples.

According to the description of the foregoing implementations, persons skilled in the art can clearly understand that the method in the foregoing embodiments may be implemented by a computer software product in combination with a necessary general hardware platform. Specifically, the method in the foregoing embodiments may alternatively be implemented by hardware. The computer software product is stored in a storage medium (such as a ROM, a RAM, a magnetic disk, or an optical disc), and includes several instructions to enable a terminal or a network-side device to execute the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other implementation manners without departing from principles of this application and the protection scope of the claims, many and all such implementation manners fall within the protection scope of this application.

What is claimed is:

1. An information processing method, performed by a third communication device, comprising:
when a tenth condition is met, performing a third operation, wherein the third operation comprises:
determining to apply Protocol Data Unit (PDU) Set based handling,
wherein the applying PDU Set based handling comprises: applying PDU Set Quality of Service (QoS),
wherein the tenth condition comprises:
a second communication device supports PDU Set based handling, or supports PDU Set based handling in uplink,
wherein the second communication device comprises a Radio Access Network (RAN) node.

2. The method according to claim 1, wherein applying the PDU Set QoS comprises:
performing QoS processing at a PDU Set level.

3. The method according to claim 1, wherein the third operation further comprises:
applying PDU Set based handling to uplink, and
applying PDU Set based handling to downlink, wherein:
determining at least one of the following:
supporting PDU Set based handling;
supporting PDU Set based handling in uplink; or
supporting PDU Set based handling in downlink;
obtaining or determining at least one of the following: the PDU Set QoS, second information, third information, or fourth information;
sending at least one of the following: the PDU Set QoS, the second information, the third information, or the fourth information;
obtaining at least one of requested PDU Set QoS, a first request, fifth information, or first capability information; and
based on at least one of the requested PDU Set QoS, the first request, the fifth information, or the first capability information, performing a first sub-operation of the third operation, or performing a second sub-operation of the third operation,
wherein:
the first sub-operation of the third operation comprises at least one of the following:
accepting the first request;
determining at least one of the PDU Set QoS, the second information, the third information, the fourth information, or the first response; or
sending at least one of the following to at least one of a first communication device and the second communication device: the PDU Set QoS, the second information, the third information, the fourth information, or the first response, wherein
the second sub-operation of the third operation comprises at least one of the following:
determining, based on the first request of a first QoS flow, the first request corresponding to a first policy; or
sending at least one of the requested PDU Set QoS, the first request, the fifth information, or the first capability information to a fourth communication device, wherein:
the first request is used to request at least one of the following: PDU Set based handling;
the first capability information is used for indicating one of the following: PDU Set based handling is supported for a terminal, uplink PDU Set based handling is supported for the terminal;
the second information is used for indicating at least one of the following: applying PDU Set importance, or applying PDU Set importance-based handling;
the third information is used for indicating at least one of the following: applying PDU Set based handling, applying PDU Set based handling to uplink, or applying PDU Set based handling to downlink;
the fourth information is used for indicating at least one of the following: supporting PDU Set based handling, supporting PDU Set based handling in uplink, or supporting PDU Set based handling in downlink;
the fifth information is used for indicating one of the following: information that PDU Set based handling is supported in uplink; and
the first response comprises information for accepting or rejecting a first request.

4. The method according to claim 1, wherein the tenth condition is met further comprises at least one of:
obtaining or determining the PDU Set QoS; or
obtaining or determining the second information, wherein the second information is used for indicating at least one of:
applying the PDU Set importance, or applying a processing based on the PDU Set importance;
a terminal supports PDU Set based handling, or supports PDU Set based handling in uplink;
an anchor gateway supports PDU Set based handling, or supports PDU Set based handling in downlink; or
fifth information indicating information on support for PDU Set based handling in uplink.

5. The method according to claim 3, wherein when a fourteenth condition is met, performing at least one of the following:
accepting the first request;
determining to apply PDU Set based handling to downlink;
determining that PDU Set based handling is supported in downlink; or
sending at least one of the PDU Set QoS, the second information, the third information, the fourth information, or the first response; wherein
the meeting the fourteenth condition comprises at least one of the following:
the PDU Set QoS has been obtained or determined;
protocol information used for PDU Set marking has been obtained or determined;
second information has been obtained or determined, and the second information indicates one of the following: applying PDU Set importance, or applying PDU Set importance-based handling;
PDU Set based handling is supported or downlink PDU Set based handling is supported for the second communication device; or
PDU Set based handling is supported or downlink PDU Set based handling is supported for an anchor gateway, wherein:
the first request comprises information for requesting PDU Set based handling for downlink;
the second information indicates at least one of the following: applying PDU Set importance, or applying PDU Set importance-based handling;
the third information indicates applying PDU Set based handling to downlink; and
the fourth information indicates that PDU Set based handling is supported in downlink.

6. The method according to claim 3, wherein
when a fifteenth condition is met, performing at least one of the following:
accepting the first request;
determining to apply PDU Set based handling to uplink;
determining that PDU Set based handling is supported in uplink; or
sending at least one of the PDU Set QoS, the second information, the third information, the fourth information, or the first response; wherein
the meeting the fifteenth condition comprises at least one of the following:
the PDU Set QoS is obtained or determined, and the second information indicates at least one of the following: applying PDU Set importance, or applying PDU Set importance-based handling;
the first request is obtained;
PDU Set based handling is supported or uplink PDU Set based handling is supported for the RAN node;
PDU Set based handling is supported or uplink PDU Set based handling is supported for the terminal; or
the fifth information indicates information that PDU Set based handling is supported in uplink, wherein
the second information indicates at least one of the following: applying PDU Set importance, or applying PDU Set importance-based handling;
the third information indicates applying PDU Set based handling to uplink;
the fourth information indicates that PDU Set based handling is supported in uplink; and
the first response comprises information for accepting the first request.

7. The method according to claim 3, wherein,
when a seventeenth condition is met, sending the first request to the fourth communication device,
wherein meeting the seventeenth condition comprises at least one of the following:
determining that PDU based Set handling is supported, or determining that PDU Set based handling is supported in uplink;
the first request is obtained;
the terminal supports PDU Set based handling, or the terminal supports PDU Set based handling in uplink;
PDU Set based handling is not applied to an uplink of a third object, or PDU Set based handling is not applied to the third object;
it is unclear whether the third object supports PDU Set based handling, it is unclear whether the third object supports PDU Set based handling in uplink, the third object supports PDU Set based handling, or the third object supports PDU Set based handling in uplink; or
at least one of the PDU Set QoS, the second information, the third information, the fourth information, or the first response corresponding to the third object does not exist,
wherein the third object comprises at least one of the following: the first QoS flow or a first rule.

8. The method according to claim 3, wherein the third operation further comprises:
after sending the first request to the fourth communication device, receiving the first information sent by the fourth communication device; and
performing the first sub-operation of the third operation based on at least one of the first information, the first capability information, or a second request.

9. A third communication device, comprising:
a memory storing computer-readable instructions; and
a processor coupled to the memory and configured to execute the computer-readable instructions, wherein the computer-readable instructions, when executed by the processor, cause the processor to perform operations comprising:
when a tenth condition is met, performing a third operation, wherein the third operation comprises:
determining to apply Protocol Data Unit (PDU) Set based handling,
wherein the applying PDU Set based handling comprises: applying PDU Set Quality of Service (QoS),
wherein the tenth condition comprises:
a second communication device supports PDU Set based handling, or supports PDU Set based handling in uplink,
wherein the second communication device comprises a Radio Access Network (RAN) node.

10. The third communication device according to claim 9, wherein applying the PDU Set QoS comprises:
performing QoS processing at a PDU Set level.

11. The third communication device according to claim 9, wherein the third operation further comprises:
applying PDU Set based handling to uplink, and
applying PDU Set based handling to downlink, wherein:
determining at least one of the following:
supporting PDU Set based handling;
supporting PDU Set based handling in uplink; or
supporting PDU Set based handling in downlink;
obtaining or determining at least one of the following: the PDU Set QoS, second information, third information, or fourth information;
sending at least one of the following: the PDU Set QoS, the second information, the third information, or the fourth information;
obtaining at least one of requested PDU Set QoS, a first request, fifth information, or first capability information; and
based on at least one of the requested PDU Set QoS, the first request, the fifth information, or the first capability information, performing a first sub-operation of the third operation, or performing a second sub-operation of the third operation,
wherein:
the first sub-operation of the third operation comprises at least one of the following:
accepting the first request;
determining at least one of the PDU Set QoS, the second information, the third information, the fourth information, or the first response; or
sending at least one of the following to at least one of a first communication device and the second communication device: the PDU Set QoS, the second information, the third information, the fourth information, or the first response, wherein
the second sub-operation of the third operation comprises at least one of the following:
determining, based on the first request of a first QoS flow, the first request corresponding to a first policy; or
sending at least one of the requested PDU Set QoS, the first request, the fifth information, or the first capability information to a fourth communication device, wherein:
the first request is used to request at least one of the following: PDU Set based handling;
the first capability information is used for indicating one of the following: PDU Set based handling is supported for a terminal, uplink PDU Set based handling is supported for the terminal;
the second information is used for indicating at least one of the following: applying PDU Set importance, or applying PDU Set importance-based handling;
the third information is used for indicating at least one of the following: applying PDU Set based handling, applying PDU Set based handling to uplink, or applying PDU Set based handling to downlink;
the fourth information is used for indicating at least one of the following: supporting PDU Set based handling, supporting PDU Set based handling in uplink, or supporting PDU Set based handling in downlink;
the fifth information is used for indicating one of the following: information that PDU Set based handling is supported in uplink; and
the first response comprises information for accepting or rejecting a first request.

12. The third communication device according to claim 9, wherein the tenth condition is met further comprises at least one of:
obtaining or determining the PDU Set QoS; or
obtaining or determining the second information, wherein the second information is used for indicating at least one of:
applying the PDU Set importance, or applying a processing based on the PDU Set importance;
a terminal supports PDU Set based handling, or supports PDU Set based handling in uplink;
an anchor gateway supports PDU Set based handling, or supports PDU Set based handling in downlink; or
fifth information indicating information on support for PDU Set based handling in uplink.

13. The third communication device according to claim 11, wherein when a fourteenth condition is met, performing at least one of the following:
accepting the first request;
determining to apply PDU Set based handling to downlink;
determining that PDU Set based handling is supported in downlink; or
sending at least one of the PDU Set QoS, the second information, the third information, the fourth information, or the first response; wherein
the meeting the fourteenth condition comprises at least one of the following:
the PDU Set QoS has been obtained or determined;
protocol information used for PDU Set marking has been obtained or determined;
second information has been obtained or determined, and the second information indicates one of the following: applying PDU Set importance, or applying PDU Set importance-based handling;
PDU Set based handling is supported or downlink PDU Set based handling is supported for the second communication device; or
PDU Set based handling is supported or downlink PDU Set based handling is supported for an anchor gateway, wherein:
the first request comprises information for requesting PDU Set based handling for downlink;
the second information indicates at least one of the following: applying PDU Set importance, or applying PDU Set importance-based handling;
the third information indicates applying PDU Set based handling to downlink; and
the fourth information indicates that PDU Set based handling is supported in downlink.

14. The third communication device according to claim 11, wherein
when a fifteenth condition is met, performing at least one of the following:
accepting the first request;
determining to apply PDU Set based handling to uplink;
determining that PDU Set based handling is supported in uplink; or
sending at least one of the PDU Set QoS, the second information, the third information, the fourth information, or the first response; wherein
the meeting the fifteenth condition comprises at least one of the following:
the PDU Set QoS is obtained or determined, and the second information indicates at least one of the following: applying PDU Set importance, or applying PDU Set importance-based handling;
the first request is obtained;
PDU Set based handling is supported or uplink PDU Set based handling is supported for the RAN node;
PDU Set based handling is supported or uplink PDU Set based handling is supported for the terminal; or
the fifth information indicates information that PDU Set based handling is supported in uplink, wherein
the second information indicates at least one of the following: applying PDU Set importance, or applying PDU Set importance-based handling;
the third information indicates applying PDU Set based handling to uplink;
the fourth information indicates that PDU Set based handling is supported in uplink; and
the first response comprises information for accepting the first request.

15. The third communication device according to claim 11, wherein,
when a seventeenth condition is met, sending the first request to the fourth communication device,
wherein meeting the seventeenth condition comprises at least one of the following:
determining that PDU based Set handling is supported, or determining that PDU Set based handling is supported in uplink;
the first request is obtained;
the terminal supports PDU Set based handling, or the terminal supports PDU Set based handling in uplink;
PDU Set based handling is not applied to an uplink of a third object, or PDU Set based handling is not applied to the third object;
it is unclear whether the third object supports PDU Set based handling, it is unclear whether the third object supports PDU Set based handling in uplink, the third object supports PDU Set based handling, or the third object supports PDU Set based handling in uplink; or
at least one of the PDU Set QoS, the second information, the third information, the fourth information, or the first response corresponding to the third object does not exist,
wherein the third object comprises at least one of the following: the first QoS flow or a first rule.

16. The third communication device according to claim 11, wherein the third operation further comprises:
after sending the first request to the fourth communication device, receiving the first information sent by the fourth communication device; and
performing the first sub-operation of the third operation based on at least one of the first information, the first capability information, or a second request.

17. A non-transitory computer-readable medium storing instructions that, when executed by a processor of a third communication device, cause the processor to perform operations comprising:
when a tenth condition is met, performing a third operation, wherein the third operation comprises:
determining to apply Protocol Data Unit (PDU) Set based handling,
wherein the applying PDU Set based handling comprises: applying PDU Set Quality of Service (QoS),
wherein the tenth condition comprises:
a second communication device supports PDU Set based handling, or supports PDU Set based handling in uplink,
wherein the second communication device comprises a Radio Access Network (RAN) node.

18. The non-transitory computer-readable medium according to claim 17, wherein applying the PDU Set QoS comprises:
performing QoS processing at a PDU Set level.

19. The non-transitory computer-readable medium according to claim 17, wherein the third operation further comprises:
applying PDU Set based handling to uplink, and
applying PDU Set based handling to downlink, wherein:
determining at least one of the following:
supporting PDU Set based handling;
supporting PDU Set based handling in uplink; or
supporting PDU Set based handling in downlink;
obtaining or determining at least one of the following: the PDU Set QoS, second information, third information, or fourth information;
sending at least one of the following: the PDU Set QoS, the second information, the third information, or the fourth information;
obtaining at least one of requested PDU Set QoS, a first request, fifth information, or first capability information; and
based on at least one of the requested PDU Set QoS, the first request, the fifth information, or the first capability information, performing a first sub-operation of the third operation, or performing a second sub-operation of the third operation,
wherein:
the first sub-operation of the third operation comprises at least one of the following:
accepting the first request;
determining at least one of the PDU Set QoS, the second information, the third information, the fourth information, or the first response; or
sending at least one of the following to at least one of a first communication device and the second communication device: the PDU Set QoS, the second information, the third information, the fourth information, or the first response, wherein
the second sub-operation of the third operation comprises at least one of the following:
determining, based on the first request of a first QoS flow, the first request corresponding to a first policy; or
sending at least one of the requested PDU Set QoS, the first request, the fifth information, or the first capability information to a fourth communication device, wherein:
the first request is used to request at least one of the following: PDU Set based handling;
the first capability information is used for indicating one of the following: PDU Set based handling is supported for a terminal, uplink PDU Set based handling is supported for the terminal;
the second information is used for indicating at least one of the following: applying PDU Set importance, or applying PDU Set importance-based handling;
the third information is used for indicating at least one of the following: applying PDU Set based handling, applying PDU Set based handling to uplink, or applying PDU Set based handling to downlink;
the fourth information is used for indicating at least one of the following: supporting PDU Set based handling, supporting PDU Set based handling in uplink, or supporting PDU Set based handling in downlink;
the fifth information is used for indicating one of the following: information that PDU Set based handling is supported in uplink; and
the first response comprises information for accepting or rejecting a first request.

20. The non-transitory computer-readable medium according to claim 17, wherein the tenth condition is met further comprises at least one of:
obtaining or determining the PDU Set QoS; or
obtaining or determining the second information, wherein the second information is used for indicating at least one of:
applying the PDU Set importance, or applying a processing based on the PDU Set importance;
a terminal supports PDU Set based handling, or supports PDU Set based handling in uplink;
an anchor gateway supports PDU Set based handling, or supports PDU Set based handling in downlink; or
fifth information indicating information on support for PDU Set based handling in uplink.
